(19) United States
(12) Patent Application Publication
(10) Pub. No.: US 2018/0294986 A1
(43) Pub. Date: Oct. 11, 2018

(54) Methods Circuits Devices Systems Platforms and Functionally Associated Machine Executable Code for Generating and Operating an Online Interactivity Environment

(71) Applicant: INVAR CONSULTING LIMITED, Vaduz (LI)

(72) Inventors: Vladimir Vidro, Givat-Zeev (IL); Ralf Vayntrub, Jerusalem (IL)

(21) Appl. No.: 15/947,089

(22) Filed: Apr. 6, 2018

Related U.S. Application Data
(60) Provisional application No. 62/482,804, filed on Apr. 7, 2017.

(51) Int. Cl. H04L 12/18; A63F 13/87; H04L 12/58

(52) U.S. Cl. CPC H04L 12/1822; H04L 51/046; A63F 13/87; H04L 12/1818

(57) ABSTRACT

Disclosed are methods, circuits, devices, systems, platforms and functionally associated machine executable code for generating and operating an online interactivity environment. An interactivity environment includes one or more virtual interactive spaces or screens. The online virtual interactivity environment is dynamically generated responsive to a goal, objective and/or other set of requirements declared or provided by an interactive discussion originator in connection with one or more specific subjects, topics and/or issues. The environment may be generated using one or more templates, defining parameters of at least a portion of the interactivity environment. One or more participants are invited and granted online access, concurrent and/or asynchronous, to one or more spaces of the environment based on designations/identifiers declared or provided by the interactive discussion originator.

### RELATED APPLICATIONS

This application claims the priority of applicant's U.S. Provisional Patent Application No. 62/482,804, filed Apr. 7, 2017. The disclosure of the above mentioned 62/482,804, Provisional patent application, is hereby incorporated by reference in its entirety for all purposes.

### FIELD OF THE INVENTION

The present invention generally relates to the fields of online collaboration and organization, including collaboration and organization of: group-working, e-learning and multi-participant directed discussions. More specifically, the present invention relates to methods, circuits, devices, systems, platforms and functionally associated machine executable code for generating and operating an online interactivity environment.

### BACKGROUND

A key ingredient of any business routine is the targeted preplanned discussion as the major factor of finding of an appropriate solution of arising problems. Nowadays, technology dramatically changed the mode of operation in such a way that, remaining the key ingredients of any business process, business discussions are not actually based anymore on the simultaneous presence of all the participants at certain location. Actually, employees can collaborate from remote locations, different countries and continents and different time zones worldwide.

A wide spectrum of techniques is utilized to organize work in online-groups: e-mailing, videoconferencing, instant messaging, chats, forums, wiki and whiteboards, to name a few. These techniques address diverse challenges such as joint execution of documents, planning, project management, generation of ideas, information exchange, debating issues, making decisions and learning processes.

The major goal and indisputable advantage of online groups is the possibility to unite efforts of people separated by time and space to carry out work requiring interaction and collaboration.

An important constituent of online group activity, practical or educational, is the discussion of the relevant content: the topics at issue, participants' attitudes, suggestions and proposals, results obtained, and etc. Due to the specifics of virtual communications, by no means all the well proved ways of face-to-face interaction and collaboration may be directly transferred to the online environment. This is reason for some of the drawbacks of the known methods of online group work organization implemented in the form of internet services or online discussions.

Chats, forums, e-mail, and teleconferences are provided only for written communication and do not suit facilitated discussions and group interaction as they lack mechanisms to influence engagement in teamwork to effect a purpose.

Wiki and other techniques applicable for working out documents in cooperation are not intended for conversation and interaction between groups.

Videoconferences and webinars enable online group partners to interact through chatting by interchanging audio and video data and written messages, but may be used for synchronous performance in this mode by only a small number of participants. Facilitation, of a discussion in this case is provided by an instructor, of the session. Such techniques are nevertheless short of complementary means of influence on group work and mechanisms of interaction between groups. In case of multiple participants, a videoconference or a webinar turns into mere one-way conveyance of information and does not allow for the feature of group work.

Learning management systems are provided with the functionality of forming groups and checking the results affected by their membership, nevertheless, the e-learning course group work is restricted by debating topics in chats and forums.

The ‘whiteboard’ technique services imply teamwork for creation of visual and textual content and sometimes—for its structuring and commentary on the created content, but are not adapted either for facilitated discussions or for interaction between groups.

Internet game services may allow for productive combined actions in a group but without possibility to vary settings and solve problems not preprogrammed.

The above shortcomings result in low motivation and weak involvement of the participants, insufficient confidence, poor communication and imitation of collaboration. Taken together, the drawbacks resident in the known methods of online group discussion may lead to low productivity and insufficient quality of results. This is especially evident when mass discussions are organized.

Moreover, frequently the existing methods of discussions in virtual groups can easily be reduced to the creation of illusion of the physical presence of participants by the means of audio and video communications. These illusions, however, are never complete and thus the efficiency of such discussions leaves a lot to be desired. The simultaneous presence of the participants on-line remains the necessary condition precisely as in the case of ordinary non-virtual discussion. One of the main factors challenging the efficiency of these discussions remains the necessity of transfer of non-verbal information in addition to the verbal communication. The major idea behind the existing inventions in the field is to reduce the virtual discussion to the regular discussion. U.S. Pat. No. 8,022,977, for example, describes a particular arrangement of camera and display that allows an actual eye contact between the participants like in case of normal discussion for nonverbal communication. Such methodologies may establish eye contact in video conferencing but for the cases of relatively large number of participants its application is limited, as the new era requires new approaches to be developed.

This new reality dictates a necessity of methods, systems and tools facilitating the targeted business discussion in the situation where an actual gathering of participants in one office can be exchanged by their virtual presence while such digitally assisted discussion across various time zones and geographical locations while maintaining an effective and well-arranged virtual discussion.

Accordingly, there remains a need, in the fields of online collaboration and organization, for solutions facilitating online discussion for minor and major groups, with a changing amount/number of participants over time. Such solutions may enable proper participant scoring and selection yielding efficient/good/productive/goal-driven collaboration and conversation in both synchronous and asynchronous modes, while combining various discussion algorithms logics and formats, purposeful grouping, and collaboration tools transposed to the virtual environment.

### SUMMARY OF THE INVENTION

According to some embodiments of the present invention, nonverbal communication in virtual discussions may be facilitated based on digital means and techniques that may not have direct analogous techniques in regular discussions. These digital means of non-verbal communication may have a hierarchical structure implemented into the entire discussion process. The hierarchical structure and its changing dynamics may be planned in the course of a planning stage of a discussion along with other key discussion ingredients.

As online discussions often tend to have a changing number of participants over time, the change in the number of participants may, for example, occur naturally when the initial number of participants is very high, as in the case of corporative discussion in large corporations. Therefore, future selection of participants may be planned in order to converge-to/facilitate reasonable corporative conclusions.

According to some embodiments, a system executed/operated algorithm/logic for dynamic selection of participants over time may be applied in changing participant number within discussion environments. Such an algorithm/logic, in accordance with some embodiments, may be at least partially based on the continuous scoring of participants; and, their division into hierarchies and their dynamic shifting between hierarchies, based thereof. The participant scoring and the changing of participants' hierarchies over time, may be likewise applicable for situations when participants have different locations and participate in discussion non-simultaneously. Facilitating a system and an algorithm/logic for participant selection, in accordance with some embodiments, may be based on dynamic participant portraying, participant scoring and dynamic participants' hierarchies updating.

According to some embodiments, there may be provided methods, circuits, devices, systems, platforms and functionally associated machine executable code for generating and operating an online interactivity environment, wherein each interactivity environment may include one or more virtual interactive spaces or screens. According to some embodiments, an online virtual interactivity environment may be dynamically generated responsive to a goal, objective and/or other set of requirements declared or provided by an interactive discussion originator in connection with one or more specific subjects, topics and/or issues. The environment may be generated using one or more templates, wherein a template according to embodiments, may define parameters of at least a portion of the interactivity environment, for example a virtual space or screen of the environment. The originator may also declare or provide one or more designations/identifiers of participants to be invited and granted online access, concurrent and asynchronous, to one or more spaces/screens of the environment. Designations of the participants may be explicit, for example by name, phone number and/or email. Alternatively, some participant designations may be implicit, for example, by role, current activity, integrated score acquired in the process of the discussion that is based on participant's discussion portrait and/or other participant parameters (e.g. experience level or knowledge base) relating to an organization, a topic, a specific discussion, or a situation.

Facilitated by a computing platform within which the interactivity environment is dynamically instanced and/or deployed responsive to an originator's declaration of a topic and goal, the interactivity environment may be configured and may operate so as to lead one or more participants on an interactive journey, wherein the interactive journey may be a multistage interactive journey which includes one or more virtual spaces or screens in which participants receive information, interact with one another, interact with the originator and/or participate in games, simulations and content production. The interactive journey may include multimedia content presentations relating to the declared topic, which presentations may be prerecorded and/or dynamically generated, and the journey may include guided and/or moderated discussions over environment facilitated channels. The guided and/or moderated discussions may be facilitated between participants and/or between a moderator and one or more participants, which moderator may or may not be the originator of the environment.

According to further embodiments, there may be provided an interactivity environment deployment application, system or engine, which application/system/engine may be integral or otherwise functionally associated with a networked computing platform on which an environment will be deployed—that is instanced and operated. The interactivity environment deployment application and/or a goal achievement logic thereof, may use originator provided topics/subjects/issues and goals in order to select or suggest one or more environment templates, each of which templates may define parameters of at least a portion of the interactivity environment. A template according to embodiments of the present invention may define at least a portion of a virtual space/screen of the interactivity environment, and a set of templates may define a set of virtual spaces/screens within a complete interactivity environment according to an embodiment of the present invention.

According to some embodiments, a set of templates combined together may form the discussion desk, presenting/providing-access-to the history of the discussion, its current state, participant's positions, their comments and/or their verbal and non-verbal reactions. Various areas and discussion sub-fields, of the discussion field, may receive different meanings and different significances, changing over time, during the course of the discussion. Thus the platform may create a dynamic time-dependent hierarchy of the discussion sub-fields. This hierarchy of discussion sub-fields may be consistent/in-sync with other system time-dependent hierarchies, including at least the hierarchy of participants and the hierarchy of non-verbal tools.

An environment template, in accordance with some embodiments, may at least partially include definitions and parameters for the rendering and managing of a ‘Discussion Desk’ including discussion fields arranged such that specific discussion fields have/correspond-to different destinations. Specific discussion fields may contain information on: ideas, reactions of participants, plans of participants, participant actions, participant given scores and/or the like. These fields, or areas, may differ from each other in: their contained information and/or their contained information history; their importance level and/or their urgency; and/or their position, size, orientation, color or the like.

Template parameters may include audio/visual rendering aspects and interactive elements, or tools, to be rendered as part of a virtual discussion desk, space and/or screen. Template parameters may include definitions of communication channels (text, audio, video, etc.) available within a discussion desk, a virtual space or a screen of the environment. Template parameters and hierarchy of participants may include/define participant communication channel access privileges. Template parameters may also include discussion parameters for utilization by the goal achievement logic to direct participant activity within a virtual space, or between multiple virtual spaces, of the environment, towards achieving the goal(s) for which the interactivity environment was deployed.

According to some embodiments of the present invention, templates defining parameters of at least a portion of the interactivity environment, for example a virtual discussion desk, space and/or screen of the environment, may include environmental elements such as control and display elements enabling an originator, a moderator and/or participants of a given interactivity environment desk/space/screen to control and thus affect, through one or more interface controls/tools rendered as part of the virtual desk/space/screen, the process or flow of the discussion stage(s) associated with it. Template based desks/spaces/screens may include graphic control and display elements enabling structured exchange of information and content between the discussion originator, moderator and/or the participants within the given space/screen. Such template defining elements and controls may serve to manage: time-dependent hierarchies of discussion sub-fields, participants' verbal non-verbal means, the correspondence between participants and the journey/process leading towards the discussion goal.

The information and content exchanged over desks/spaces/screens may include a combination of verbal and non-verbal statements/data. For example, verbal information which may include explicit message types such as written or recorded language; and/or non-verbal information which may include information derived from implicit message types associated to statement/data characteristics such as: time of/to participant statement, type of statement (e.g. new, in-response), participant positioning place of the statement tool (e.g. message, sticker, token) over the ‘discussion desk’, participant selected properties for the statement tool (e.g. color, size or shape of sticker/token) and/or more.

A sticker, in accordance with some embodiments, may take the form of a multifunctional mobile object for both verbal and non-verbal information, while a token may be a mobile carrier of non-verbal information that may, for example, be positioned within the sticker. Both stickers and tokens may have different shapes, colors, and positions.

Template types for rendering desks/spaces/screens may for example include: Brainstorming templates, Multistage Voting templates, Priorities Setting templates, Paired Comparison template, Dialogue Opinion Collection template, Phrasing Synthesis template, Storytelling template, and/or Collaborative Action templates.

Template defined elements for rendering within a space of an environment according to embodiments of the present invention may include two dimensional stickers with one or more text input fields. One or more stickers of a space may be assigned to and owned by a participant with access to the space, where a sticker owner may have privileges to enter text into a first field of the sticker, while participants who do not own the sticker but with access to the space may enter text into other text fields. A sticker's positioning within an environment space may be controlled/modified by the sticker owner, by the moderator, by goal achievement logic of the space, and/or by other participants as defined by the goal achievement logic. Locations or segments within an environment space, where stickers may be positioned, may have differing significance or meanings as defined by a template used to generate the space. Different locations or segments within a space associated with differing meanings may also be rendered differently and may have different appearances within the environment space, again, as defined within a template used to generate the space.

An author (participant) of a statement can create the sticker with his verbal statement on a certain issue and position this statement in a certain place of the discussion desk. The position of the sticker in the discussion field, its color, shape and timing are significant, as they may represent non-verbal ways of communication. The moving of the sticker from zone to zone, while considering the hierarchy of discussion sub-fields, may reflect the change in the position of the author of the statement during the discussion. Within the stickers themselves tokens may be placed. A token, in accordance with some embodiments, is a mobile carrier of non-verbal information, designed with the purpose of evaluating the statements of other participants. Such an evaluation may have a digital or semantic (e.g. reactions, emotions, actions, recommendations) expression and, may for example be displayed in the form of: prepared icons, symbols and/or graphic visualizations. Tokens can be of different shapes and colors. Differences in the form of tokens may be used to visually identify an assessment category. Tokens may, for example, be placed on stickers and/or in specialized areas of the discussion desk

According to some embodiments, deployment of an online virtual interactivity environment—dynamically generated responsive to a goal, objective and/or other set of requirements declared or provided by an interactive discussion originator in connection with one or more specific subjects, topics and/or issues—may, for example, include: building one or more virtual environment spaces/screens, connecting the spaces/screens built and/or allocating participants to spaces/screens.

Building one or more virtual environment spaces/screens may be based on discussion originator selected templates and/or based on templates that are associated with a discussion type, structure and/or algorithm selected by the originator. Building spaces/screens may for example include: building virtual interactivity environment by the rendering of backgrounds, display and control/interface elements (e.g. graphic space/screen control elements); instancing of communication channels in and out of the space/screen being built, wherein information and content types to be communicated over instanced channels may for example include: text, sound, video, whiteboard, links, graphs and/or the like; and/or optionally generating multiple duplicates of the same space/screen to account for a large number of participants, for example a large number of participants whose inputs or participation are required/aspired in regard to the same discussion stage, while parameters of the template associated the space/screen limit the number of participants in a single such space/screen as to increase discussion efficiency and/or improve its outcomes.

Connecting the spaces/screens built, may for example include: defining the interconnection(s) between various discussion sub-fields, the space/screens and their order; generating one or more rules, or rule-sets, for allowing participants to continue from one space/screen to another, wherein rules or rule-sets may for example include participant position and/or qualities based inclusion or filtering-out rules and/or rules based on the outcomes of one or more prior discussion stages. Thus, the dynamic changes in the hierarchy of discussion sub-fields may be realized.

Allocating participants to spaces/screens at a relevant point(s) in an environment may be made in accordance with originator definition(s) of environment goals, participants defined role(s), etc. Wherein allocating may for example include: allocating specific participants to all or some of the spaces/screens of an environment; and/or providing specific participants with access to specific communication channels for specific participant accessible spaces in accordance with privileges either explicitly defined by the discussion originator or based on participant role.

Various participants depending on their roles in discussion and their current scores may be granted or denied access to different stickers and/or tokens and to other verbal and non-verbal means. Thus, the interconnection and correspondence between the hierarchies of the tools and the hierarchy of participants may be realized and utilized.

The goal achievement logic, in accordance with embodiments of the present invention, may control the flow of participants from space to space, on their journey to complete the originator's goal in connection with the declared topic/subject/issue. The hierarchies of the verbal and non-verbal tools may be modified, the hierarchy of participants may be changed, and the interconnection between these hierarchies may be modified—as at the certain stages of the discussion the access to the certain type of stickers, tokens and discussion fields may be granted to the certain participants or to the certain groups of participants. All participants' actions and moves may be recorded thus realizing participant discussion portraying for their current and future scoring. This scoring in its turn may serve as a key output for further participant selection. The goal achievement logic may designate, select or suggest one or more participants, out of a pool of potential participants, for inclusion in each of the screens or spaces within the interactivity environment. According to some embodiments, the goal achievement logic may designate, select or suggest participants for partaking in a given space based on parameters received from an originator or a moderator of the interactivity environment, based on template defined parameters of the template(s) associated with the given space and/or based on outcomes or results of participant's interactivity within other spaces of the interactivity environment at prior stages of the interactive journey.

Participant selection parameters received from an originator or a moderator of the interactivity environment may include explicit and direct selection of participants; and/or implicit selection of participants based on participant characteristics (e.g. role, experience, title, availability) or based on an originator's or a moderator's aspired participant mix and/or number within a specific given space or screen of the interactivity environment. Template defined parameters may include a suggested or required participant mix, participant characterization mix and/or participant number within a specific given space or screen associated with the template. Outcomes or results of participant's interactivity within other, prior stage, spaces of the interactivity environment may affect participant selection by the goal achievement logic. For example, in a discussion seeking a participant agreement/consent, a low level of consensus within a given interactivity environment discussion space, may trigger an increase in the number of aspired participants in following spaces, as to try and create a more homogeneous opinion, whereas a high level of consensus within the given interactivity environment discussion space may trigger a decrease in the number of aspired participants in following spaces, as a substantially homogeneous opinion has already been reached/crystallized.

According to some embodiments, a participant discussion portrait may act as a tool for participants selection. The discussion portrait of a participant may include such parameters as: (1) timing of the entrance to the session and the exit from the session and/or to/from the certain discussion field, (2) timing when certain type of verbal statement was made, when certain kind of stickers and/or tokens were used, positioned, repositioned and/or removed; (3) time intervals needed to create/delete certain stickers or tokens and/or to make certain verbal statements; (4) usage of widgets: viewing videos, presentations; (5) verbal activities such as broadcasting in the panel and/or making posts in the chat sessions; (6) passing tests, formal test scores, etc. Based on the exemplary above data, the discussion portrait of each participant may be monitored in the course of the entire discussion. It includes combined parameters such as, for instance, the activity index, i.e. the number of events of a certain type created by the user for a certain time interval and the reciprocity index, i.e. the ratio of the created estimates and comments to the received estimates and comments. In addition to the above, the discussion portrait of a participant may also include reports on past stages of the discussion with printout of all stickers, tokens, comments, estimates, their creation time, their placement area, design, timing, etc. An acquired scoring of participant may be a function solely, or partially, based/calculated-based on his discussion portrait.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

FIG. 1A, is a block diagram showing the main modules of an exemplary system for generating and operating an online interactivity environment and the interoperation of the shown modules, in accordance with some embodiments of the present invention;

FIG. 1B, is a block diagram showing, in further detail, the main modules and sub components thereof, of an exemplary system for generating and operating an online interactivity environment and the interoperation of the shown modules, in accordance with some embodiments of the present invention;

FIG. 2, is a screenshot of an exemplary discussion conduct toolkit interface and control panels thereof, in accordance with some embodiments of the present invention;

FIG. 3A, is a flow diagram showing a participant groups dynamics based structure, of an exemplary system facilitated discussion, as part of a journey through a system generated interactivity environment, in accordance with some embodiments of the present invention;

FIG. 3B, is a set of diagrams showing exemplary participant hierarchies, of an exemplary system facilitated discussion, utilized as part of a journey through a system generated interactivity environment, in accordance with some embodiments of the present invention;

FIG. 3C, is a set of diagrams showing exemplary access privilege hierarchies, along with their corresponding Sticker tools usage hierarchies and token tools setting hierarchies, of an exemplary system facilitated discussion, as part of a journey through a system generated interactivity environment, in accordance with some embodiments of the present invention;

FIG. 3D, is a set of diagrams showing exemplary subject/participant/role hierarchy and its corresponding tools control hierarchy, of an exemplary system facilitated discussion, as part of a journey through a system generated interactivity environment, in accordance with some embodiments of the present invention;

FIG. 4 is a table depicting participant groups forming dynamics, of an exemplary system facilitated discussion, as part of a journey through a system generated interactivity environment, in accordance with some embodiments of the present invention;

FIG. 5, is a screenshot of an exemplary information board presenting analytical data relating to work results of a participant discussion group, in accordance with some embodiments of the present invention;

FIG. 6, is a screenshot of an exemplary discussion field/space/screen, including and/or used for the managing of, or interfacing with, different kinds of stickers including text input fields, which stickers are assigned to and owned by a specific participant(s) in, an originator of and/or a moderator of the discussion, having access to the exemplary discussion field/space/screen, in accordance with some embodiments of the present invention;

FIG. 7, is a screenshot of an exemplary space/screen including two dimensional stickers with one or more text input fields. In the figure a reverse input field(s) of a selected sticker is shown, wherein the reverse input field(s) may be utilized by participants of the space/screen for locating posts in the form of text messages, visual images, estimation marks and/or other objects, in accordance with some embodiments of the present invention;

FIGS. 8A-8E, are screenshots of exemplary templates based interactivity environments, in accordance with some embodiments of the present invention, wherein:

FIG. 8A is an exemplary interactivity environment Brainstorming template;

FIG. 8B is an exemplary interactivity environment Voting template;

FIG. 8C is an exemplary interactivity environment Priorities Setting template;

FIG. 8D is an exemplary interactivity environment Paired Comparison template;

FIG. 8E is an exemplary interactivity environment Dialogue Opinion Collection template; and

FIG. 9, is a flowchart showing the main steps executed as part of a process for discussion elements hierarchies generation and discussion participants adding/removing, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer, computing system, computerized mobile device, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device, for example a computerized device running a web-browser.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution. The memory elements may, for example, at least partially include memory/registration elements on the user device itself.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

Throughout the specification, the term ‘content’, and/or any other more specific content-describing terms such as ‘visual content’, ‘photo’, ‘image’, ‘audio’, ‘video’, ‘media, or the like, is not to limit the scope of the associated teachings or features, all of which may apply to any form of digital content known today, or to devised in the future, such as, but not limited to—visual, acoustic, smell based, taste based, sense based, and/or any combination thereof.

In the following discussions, the term ‘facilitator’ may include either or both: an ‘originator’ that may refer to an initiator/planner of an interactivity environment discussion and/or a ‘moderator’ that may refer to an administrator/manager of the interactivity environment discussion. As ‘originator’ and ‘moderator’ associated roles may be executed by the same user (person) or by multiple (e.g. 2) users (persons), these three terms may be used interchangeably through the descriptions provided herein, in a non-limiting manner.

Furthermore, the terms ‘template’, ‘discussion desk’ and ‘discussion field’ may, at times, be used interchangeably through the descriptions provided herein, in a non-limiting manner; and may, for example, relate to any combination of: parameters defining and controlling a virtual discussion environment/space/screen of an interactivity environment, a participants-presented virtual discussion environment and its structural/graphical characteristics, data associated with a discussion environment/space/screen and its logged history, data fields and virtual discussion tools associated with specific discussion environments/spaces/screens and/or any other aspects of a discussion environment and participant interface thereof. The terms ‘sticker’ and ‘token’ are defined, explained and exemplified, as part of the descriptions herein.

A ‘Journey’ in accordance with some embodiments, may refer to the presentation of interactivity environment discussion spaces and/or the guided/moderated leading/directing of discussion participants within and/or between them.

An ‘interactivity Environment’ in accordance with some embodiments, may provide a journey roadmap/process for discussion. Discussion ‘templates’, system/platform logic and/or discussion facilitator inputs, may be collectively utilized to generate and deploy the journey roadmap/process for the respective discussion.

According to some embodiments, there may be provided methods, circuits, devices, systems, platforms and functionally associated machine executable code for generating and operating an online interactivity environment, wherein each interactivity environment may include one or more virtual interactive spaces or screens. According to some embodiments, an online virtual interactivity environment may be dynamically generated responsive to a goal, objective and/or other set of requirements declared or provided by an interactive discussion originator in connection with one or more specific subjects, topics and/or issues. The environment may be generated using one or more templates, wherein a template according to embodiments, may define parameters of at least a portion of the interactivity environment, for example a virtual space or screen of the environment.

The originator of a discussion may also declare or provide one or more designations/identifiers of participants to be invited and granted online access, concurrent and asynchronous, to one or more spaces/screens of the environment. Designations of the participants may be explicit, for example by name, phone number and/or email. Alternatively, some participant designations may be implicit, for example: by role, current activity and/or other participant parameters (e.g. experience level or knowledge base) relating to an organization, a topic or a situation and/or an integrated score acquired in the process of the discussion that is based on the participant's discussion portrait. Participant designations may carry respective discussion related hierarchies with them, later affecting the ability of the associated participant to access and/or utilize: parts, areas, tools and/or functionalities of the virtual discussion environment(s), or parts thereof, to which the designation was assigned.

Facilitated by a computing platform within which the interactivity environment is dynamically instanced and/or deployed responsive to an originator's declaration of a topic and goal, the interactivity environment may be configured and may operate so as to lead one or more participants on an interactive journey, wherein the interactive journey may be a multistage interactive journey which includes one or more virtual spaces or screens in which participants receive information, interact with one another, interact with the originator and/or participate in games, simulations and content production. The interactive journey may include multimedia content presentations relating to the declared topic, which presentations may be prerecorded and/or dynamically generated, and the journey may include guided and/or moderated discussions over environment facilitated channels. The guided and/or moderated discussions may be facilitated between participants and/or between a moderator and one or more participants, which moderator may or may not be the originator of the environment.

According to further embodiments, there may be provided an interactivity environment deployment application, system or engine, which application/system/engine may be integral or otherwise functionally associated with a networked computing platform on which an environment will be deployed—that is instanced and operated. The interactivity environment deployment application and/or a goal achievement logic thereof, may use originator provided topics/subjects/issues and goals in order to select or suggest one or more environment templates, each of which templates may define parameters of at least a portion of the interactivity environment. A template according to embodiments of the present invention may define at least a portion of a virtual space/screen of the interactivity environment, and a set of templates may define a set of virtual spaces/screens within a complete interactivity environment according to an embodiment of the present invention.

According to some embodiments, a set of templates combined together may form the discussion desk, presenting/providing-access-to the history of the discussion, its current state, participant's positions, their comments and/or their verbal and non-verbal reactions. Various areas and discussion sub-fields, of the discussion field, may receive different meanings and different significances, changing over time, during the course of the discussion. Thus the platform may create a dynamic time-dependent hierarchy of the discussion sub-fields. This hierarchy of discussion sub-fields may be consistent/in-sync with other system time-dependent hierarchies, including at least the hierarchy of participants and the hierarchy of non-verbal tools.

An environment template, in accordance with some embodiments, may at least partially include definitions and parameters for the rendering and managing of a ‘Discussion Desk’ including discussion fields arranged such that specific discussion fields have/correspond-to different destinations. Specific discussion fields may contain information on: ideas, reactions of participants, plans of participants, participant actions, participant given scores and/or the like. These fields, or areas, may differ from each other in: their contained information and/or their contained information history; their importance level and/or their urgency; and/or their position, size, orientation, color or the like.

Template parameters may include audio/visual rendering aspects and interactive elements, or tools, to be rendered as part of a virtual discussion desk, space and/or screen. Template parameters may include definitions of communication channels (text, audio, video, etc.) available within a discussion desk, a virtual space or a screen of the environment. Template parameters and hierarchy of participants may include participant communication channel access privileges. Template parameters may also include discussion parameters for utilization by the goal achievement logic to direct participant activity within a virtual space, or between multiple virtual spaces, of the environment, towards achieving the goal(s) for which the interactivity environment was deployed.

According to some embodiments, a set of templates combined together may form the discussion desk, presenting/providing-access-to the history of the discussion, its current state, participant's positions, their comments and/or their verbal and non-verbal reactions. Various areas and discussion sub-fields, of the discussion field, may receive different meanings and different significances, changing over time, during the course of the discussion. Thus the platform may create a dynamic time-dependent hierarchy of the discussion sub-fields. This hierarchy of discussion sub-fields may be consistent/in-sync with other system time-dependent hierarchies, including at least the hierarchy of participants and the hierarchy of non-verbal tools.

According to some embodiments of the present invention, templates defining parameters of at least a portion of the interactivity environment, for example a virtual discussion desk, space and/or screen of the environment, may include environmental elements such as control and display elements enabling an originator, a moderator and/or participants of a given interactivity environment desk/space/screen to control and thus affect, through one or more interface controls/tools rendered as part of the virtual desk/space/screen, the process or flow of the discussion stage(s) associated with it. Template based desks/spaces/screens may include graphic control and display elements enabling structured exchange of information and content between the discussion originator, moderator and/or the participants within the given space/screen. Such template defining elements and controls may serve to manage: time-dependent hierarchies of discussion sub-fields, participants' verbal non-verbal means, the correspondence between participants and the journey/process leading towards the discussion goal.

The information and content exchanged over desks/spaces/screens may include a combination of verbal and non-verbal statements/data. For example, verbal information which may include explicit message types such as written or recorded language; and/or non-verbal information which may include information derived from implicit message types associated to statement/data characteristics such as: time of/to participant statement, type of statement (e.g. new, in-response), participant positioning place of the statement tool (e.g. message, sticker, token) over the ‘discussion desk’, participant selected properties for the statement tool (e.g. color, size of sticker/token) and/or more.

According to some embodiments, non-verbal information may be also expressed by specially prepared stickers and tokens, their positioning in the discussion desk, their shapes and/or their colors. A sticker, in accordance with some embodiments, may take the form of a multifunctional mobile object for both verbal and non-verbal information, while a token may be a mobile carrier of non-verbal information that may, for example, be positioned within the sticker. Both stickers and tokens may have different shapes, colors, and positions.

A sticker, in accordance with some embodiments, may allow for the author of the statement to create the verbal statement on a certain issue and to post this statement, in the certain way chosen by him, for further discussing this statement. And, for evaluating the positions of other participants of the discussion on this statement by further comparison of the position of the author on the subject with the positions of the other participants.

The sticker can be placed by the author of the statement in the specialized/designated areas of the discussion field, wherein the placement the sticker in a certain field may reflect the author's current position on the subject of discussion regarding the positions of other participants that are reflected in other stickers.

The position of the sticker in the discussion field may be significant. Thus, moving the sticker from one position to a different position or to a different discussion sub-field reflects the change in the position of the author of the statement during the discussion. This action itself as well as its particular timing is recorded and becomes the part of participant's (author's) discussion portrait.

Template types for rendering desks/spaces/screens may for example include: Brainstorming templates, Multistage Voting templates, Priorities Setting templates, Paired Comparison template, Dialogue Opinion Collection template, Phrasing Synthesis template, Storytelling template, and/or Collaborative Action templates.

Template defined elements for rendering within a space of an environment according to embodiments of the present invention may include two dimensional stickers with one or more text input fields. One or more stickers of a space may be assigned to and owned by a participant with access to the space, where a sticker owner may have privileges to enter text into a first field of the sticker, while participants who do not own the sticker but with access to the space may enter text into other text fields. A sticker's positioning within an environment space may be controlled/modified by the sticker owner, by the moderator, by goal achievement logic of the space, and/or by other participants as defined by the goal achievement logic. Locations or segments within an environment space, where stickers may be positioned, may have differing significance or meanings as defined by a template used to generate the space. Different locations or segments within a space associated with differing meanings may also be rendered differently and may have different appearances within the environment space, again, as defined within a template used to generate the space.

An author (participant) of a statement can create the sticker with his verbal statement on a certain issue and position this statement in a certain place of the discussion desk. The position of the sticker in the discussion field, its color, shape and timing are significant, as they may represent non-verbal ways of communication. The moving of the sticker from zone to zone, while considering the hierarchy of discussion sub-fields, may reflect the change in the position of the author of the statement during the discussion. Within the stickers themselves tokens may be placed. A token, in accordance with some embodiments, is a mobile carrier of non-verbal information, designed with the purpose of evaluating the statements of other participants. Such an evaluation may have a digital or semantic (e.g. reactions, emotions, actions, recommendations) expression and, may for example be displayed in the form of: prepared icons, symbols and/or graphic visualizations. Tokens can be of different shapes and colors. Differences in the form of tokens may be used to visually identify an assessment category. Tokens may, for example, be placed on stickers and/or in specialized areas of the discussion desk

According to some embodiments, deployment of an online virtual interactivity environment—dynamically generated responsive to a goal, objective and/or other set of requirements declared or provided by an interactive discussion originator in connection with one or more specific subjects, topics and/or issues—may, for example, include: building one or more virtual environment spaces/screens, connecting the spaces/screens built and/or allocating participants to spaces/screens.

Building one or more virtual environment spaces/screens may be based on discussion originator selected templates and/or based on templates that are associated with a discussion type, structure and/or algorithm selected by the originator. Building spaces/screens may for example include: building virtual interactivity environment by the rendering of backgrounds, display and control/interface elements (e.g. graphic space/screen control elements); instancing of communication channels in and out of the space/screen being built, wherein information and content types to be communicated over instanced channels may for example include: text, sound, video, whiteboard, links, graphs and/or the like; and/or optionally generating multiple duplicates of the same space/screen to account for a large number of participants, for example a large number of participants whose inputs or participation are required/aspired in regard to the same discussion stage, while parameters of the template associated the space/screen limit the number of participants in a single such space/screen as to increase discussion efficiency and/or improve its outcomes.

Connecting the spaces/screens built, may for example include: defining the interconnection(s) between various discussion sub-fields, the space/screens and their order; generating one or more rules, or rule-sets, for allowing participants to continue from one space/screen to another, wherein rules or rule-sets may for example include participant position and/or qualities based inclusion or filtering-out rules and/or rules based on the outcomes of one or more prior discussion stages. Thus, the dynamic changes in the hierarchy of discussion sub-fields may be realized.

Allocating participants to spaces/screens at a relevant point(s) in an environment may be made in accordance with originator definition(s) of environment goals, participants defined role(s), etc. Wherein allocating may for example include: allocating specific participants to all or some of the spaces/screens of an environment; and/or providing specific participants with access to specific communication channels for specific participant accessible spaces in accordance with privileges either explicitly defined by the discussion originator or based on participant role.

Various participants depending on their roles in discussion and their current scores may be granted or denied access to different stickers and/or tokens and to other verbal and non-verbal means. Thus, the interconnection and correspondence between the hierarchies of the tools and the hierarchy of participants may be realized and utilized.

The goal achievement logic, in accordance with embodiments of the present invention, may control the flow of participants from space to space, on their journey to complete the originator's goal in connection with the declared topic/subject/issue. The hierarchies of the verbal and non-verbal tools may be modified, the hierarchy of participants may be changed, and the interconnection between these hierarchies may be modified—as at the certain stages of the discussion the access to the certain type of stickers, tokens and discussion fields may be granted to the certain participants or to the certain groups of participants. All participants' actions and moves may be recorded thus realizing participant discussion portraying for their current and future scoring. This scoring in its turn may serve as a key output for further participant selection.

The hierarchy of non-verbal tools such as stickers and tokens as well as the hierarchy of participants may be defined as dynamic entities changing in time. The correspondence between the above hierarchies may be time object as well. For instance, in certain stages of discussion the participants with very high activities may be granted an access to, say, restricted red stickers while in the following stages of the discussion they already are not allowed to use or access them anymore. The changes in all the hierarchies and the correspondences between them may result from the decision of facilitator or from current evaluation of the formal scoring that is performed automatically.

The goal achievement logic may designate, select or suggest one or more participants, out of a pool of potential participants, for inclusion in each of the screens or spaces within the interactivity environment. According to some embodiments, the goal achievement logic may designate, select or suggest participants for partaking in a given space based on parameters received from an originator or a moderator of the interactivity environment, based on template defined parameters of the template(s) associated with the given space and/or based on outcomes or results of participant's interactivity within other spaces of the interactivity environment at prior stages of the interactive journey.

Participant selection parameters received from an originator or a moderator of the interactivity environment may include explicit and direct selection of participants; and/or implicit selection of participants based on participant characteristics (e.g. role, experience, title, availability) or based on an originator's or a moderator's aspired participant mix and/or number within a specific given space or screen of the interactivity environment. Template defined parameters may include a suggested or required participant mix, participant characterization mix and/or participant number within a specific given space or screen associated with the template. Outcomes or results of participant's interactivity within other, prior stage, spaces of the interactivity environment may affect participant selection by the goal achievement logic. For example, in a discussion seeking a participant agreement/consent, a low level of consensus within a given interactivity environment discussion space, may trigger an increase in the number of aspired participants in following spaces, as to try and create a more homogeneous opinion, whereas a high level of consensus within the given interactivity environment discussion space may trigger a decrease in the number of aspired participants in following spaces, as a substantially homogeneous opinion has already been reached/crystallized.

According to some embodiments, a participant discussion portrait may act as a tool for participants selection. The discussion portrait of a participant may include such parameters as: (1) timing of the entrance to the session and the exit from the session and/or to/from the certain discussion field, (2) timing when certain type of verbal statement was made, when certain kind of stickers and/or tokens were used, positioned, repositioned and/or removed; (3) time intervals needed to create/delete certain stickers or tokens and/or to make certain verbal statements; (4) usage of widgets: viewing videos, presentations; (5) verbal activities such as broadcasting in the panel and/or making posts in the chat sessions; (6) passing tests, formal test scores, etc. Based on the exemplary above data, the discussion portrait of each participant may be monitored in the course of the entire discussion. It includes combined parameters such as, for instance, the activity index, i.e. the number of events of a certain type created by the user for a certain time interval and the reciprocity index, i.e. the ratio of the created estimates and comments to the received estimates and comments. In addition to the above, the discussion portrait of a participant may also include reports on past stages of the discussion with printout of all stickers, tokens, comments, estimates, their creation time, their placement area, design, timing, etc. An acquired scoring of participant may be a function solely, or partially, based/calculated-based on his discussion portrait.

According to some embodiments, multiple formats of virtual discussions may be classified by a series of parameters (e.g. facilitator provided), such formats may include, but are not limited to: individual or collaborative discussion, free or given-frame discussion), (permanent participant list or flexible/dynamic participant list discussion), etc.

According to some embodiments, systems and methodologies described herein may be scalable and may thus be extended by conducting in parallel multiple discussions in several virtual groups wherein each separate group may have its own copy of the discussion desk; and wherein these desks are initially identical and each copy of the discussion desk gradually acquires its own individuality reflecting the character of the discussion in its particular group of participants.

According to some embodiments, for the more advanced stages of the discussion the amount of groups may be decreased and the amount of participants may be restricted as well. The participants scoring based on their discussion portraying may act as a significant tool for the selection of participants for the following stages.

A discussion elements hierarchies generation and discussion participants adding/removing method, implemented by a system or platform for generating and operating an online collaboration/discussion interactivity environment, in accordance with some embodiments, may include a combination of the following main steps: (1) Determining/Calculating the relative hierarchy of one or more non-verbal means, for example: based on the shape, color, type and/or positioning place, of one or more stickers and/or tokens positioned by participants; and/or based on gesture type hierarchy magnitude, as detected within visual content (e.g. image, video) provided/uploaded by participants; (2) Determining/Calculating hierarchies of the discussion sub-fields, at least partially based on the assessed hierarchies of means utilized within each of the sub-fields; (3) Determining/Calculating participants' hierarchies based on the hierarchies of non-verbal means and/or of hierarchy of sub-fields—associated with each of the participants; wherein, participants' hierarchies may change through the course of discussion, for example, a given participant initially having access to all stickers is later prevented from accessing a sub group of the stickers; (4) Logging the discussion, and calculating a participant's discussion portrait score for each of the participant; and/or (5) Executing a participant selection algorithm/process for adding participants to, and/or removing participants from, the discussion—at least partially based on the each participant's calculated discussion portrait score.

The exemplified method, or a sub-set of its steps, may be intermittently iterated during the course of the discussion, dynamically updating the different hierarchies, in accordance with the development of the discussion; and_{;} dynamically adding/removing participants to/from the discussion, and/or changing their access privileges, based thereof.

The following, includes non-limiting descriptions of the components, processes and functionalities of an exemplary system or platform for generating and operating an online interactivity environment, along with sub elements and methodologies thereof, in accordance with some embodiments of the present invention.

For the purposes of the following exemplary description of the invention, the following terms and definitions may apply:
“online discussion”, a discussion organized/managed using/over the Internet's virtual environment and methods and tools;
“discussion format”, a discussion type determined by a set of regulations, protocols, methods and tools;
“discussion algorithm”, a logical order of discussion stages;
“online discussion structure”, a suite of given discussion threads and virtual environment methods and tools;
“discussion tool”, a technique for implementation of one or several steps within a specific method;
“free discussion”, a discussion which is not limited by a formal framework of a consecutive order of discussion on well-defined topics;
“directed discussion”, a discussion on a specific topic applying predefined discussion algorithm(s);
“composite discussion”, a predesigned discussion featuring the stages of receiving, studying, and creating content for future discussions; and
“collanar” (i.e. collaborative seminar/webinar), a composite discussion representing a composition of at least one video broadcasting session intended for all discussion participants and a non-limited number of predesigned group discussions.

“discussion portrait” a discussion portrait of participant includes parameters such as: (1) timing of the entrance to the session and the exit from the session and/or to/from the certain discussion field, (2) timing when certain type of verbal statement was made, when certain kind of stickers and/or tokens were used, positioned, repositioned and/or removed; (3) time intervals needed to create/delete certain stickers or tokens and/or to make certain verbal statements; (4) usage of widgets: viewing videos, presentations; (5) verbal activities such as broadcasting in the panel and/or making posts in the chat sessions; (6) passing tests, formal test scores, etc. Based on the exemplary above data, the discussion portrait of each participant may be monitored in the course of the entire discussion. It includes combined parameters such as, for instance, the activity index, i.e. the number of events of a certain type created by the user for a certain time interval and the reciprocity index, i.e. the ratio of the created estimates and comments to the received estimates and comments. In addition to the above, the discussion portrait of a participant may also include reports on past stages of the discussion with printout of all stickers, tokens, comments, estimates, their creation time, their placement area, design, timing, etc. An acquired scoring of participant may be a function solely, or partially, based/calculated-based on his discussion portrait.

According to some embodiments, the described systems and methods of organizing online discussion may comprise three main phases: a planning phase, a preparation phase and a discussion phase.

### (1) Planning Phase

According to some embodiments, the planning phase may initiate with setting of a discussion goal. An online discussion organized for a limited or an unlimited number of users/participants may be targeted at one goal or a combination of goals, including, for example: finding the truth, reaching consensus, gaining understanding of participants' viewpoints, revealing advantages of a particular viewpoint, making a decision based on search for different options, data acquisition, surveys, informing and/or learning.

At least one of the participants—organizing the online discussion—is designated as facilitator and assigned access rights to administer information provision, representation, and exchange through an interface presented (e.g. client mobile application installed and running, web application) on the facilitator's computerized device (e.g. mobile, desktop). These actions may be relayed via Internet and/or local networks through control panels designed for handling facilitator-oriented software modules located at the back end of the system (e.g. on system server(s)).

A combination of software and/or hardware modules for implementation of the method may comprise at least the following modules: participants' database, access rights management, knowledge base (archive, analysis, and discussion toolkit), interactive components for content acquisition and creation, audio and video broadcast tools.

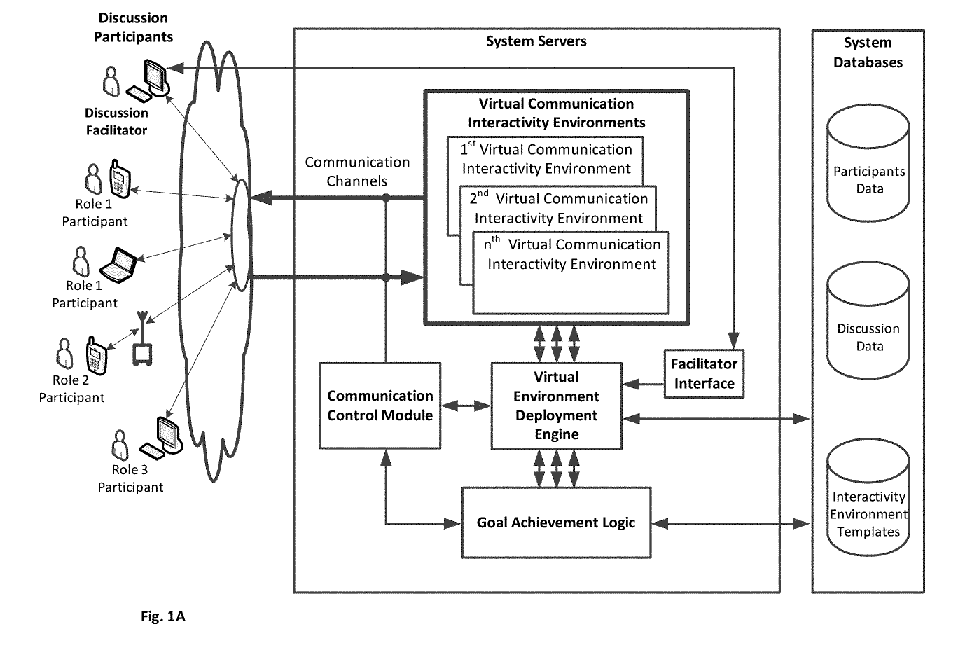

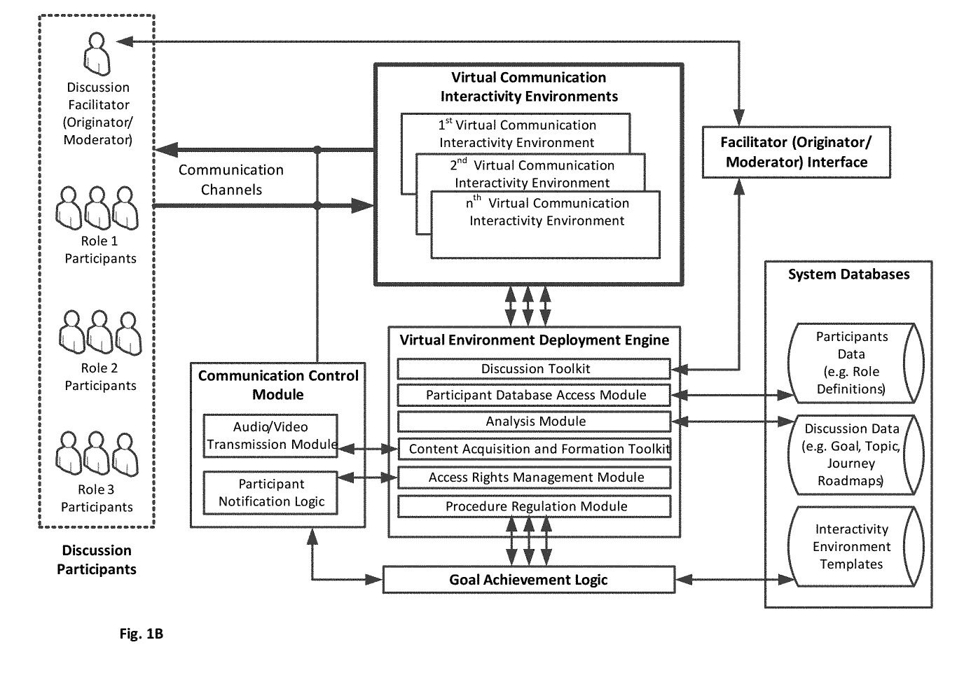

In FIG. 1A there is shown, a block diagram of the main components of an exemplary architecture of a system for generating and operating an online interactivity environment and their interoperation, in accordance with some embodiments of the present invention. In the figure, there are shown Virtual Communication Interactivity Environment(s) rendered by the shown System Server's Virtual Environment Deployment Engine, based on one or more discussion facilitator provided inputs and/or in accordance with rendering instructions embedded within one or more environment templates, selected by the shown Goal Achievement Logic for the specific discussion journey/flow/path/process roadmap, at least partially based on facilitator declared discussion goal(s) and/or facilitator provided inputs.

The facilitator inputs, provided through the shown Facilitator Interface, may include: (1) the goal(s) of the discussion; (2) inputs associated with the structure and/or flow of the discussion; (3) identifiers, roles/positions, amounts, access rights and/or grouping parameters of the discussion participants and/or of potential discussion participants; and/or (4) types and sources of content items to be used as part of the discussion.

The shown Communication Control Module may control the communication access to the one or more rendered virtual communication interactivity environments, by each of one or more participants, in accordance with: (1) role definitions associated with each of the one or more participants selected for a given discussion, and/or (b) communication channel definitions embedded within environment template(s) associated with the given discussion, or part thereof, by the Goal Achievement Logic. The Communication Control Module, may accordingly manage the access and engagement of participants, from within a given pool of participants, in one or more corresponding virtual interactivity environments of one or more discussions.

The Communication Control Module may include a Participant Notification Module for automatically notifying one or more potential discussion participants of their invitation to participate in at least part of the discussion journey through at least one of the virtual communication interactivity environments.

In the figure, multiple discussion participants are shown to access and communicate with the deployed Virtual Communication Interactivity Environment(s), thereby engaging with other participants allowed access to the same environment(s). The participants in the figure are shown to access the Virtual Communication Interactivity Environment(s) from different kinds of computerized devices (e.g. desktop, laptop, smartphone), wherein access may be made through a web/network application and/or through a client application on the participant's device. The data connection to the Interactivity Environments) may be established over the Internet and/or over, or in cooperation with, additional local networks (e.g. home/work/wide/cellular/Wi-Fi networks).

In FIG. 1B, there is shown, a block diagram presenting, in further detail, the main modules and sub components thereof, of an exemplary system for generating and operating an online interactivity environment and the interoperation of the shown modules, in accordance with some embodiments of the present invention.

The Virtual Environment Deployment Engine is shown to include, or be functionally associated with, the following sub components/modules:

(1) A discussion toolkit allowing a discussion facilitator, through a control panel(s) of the discussion toolkit, to relay and provide a discussion thread structure, wherein each discussion thread may be represented simultaneously on one or more websites and/or on one or more mobile user application interfaces on displays of computerized devices of a given discussion's participants; the discussion toolkit may be implemented as a field/screen outfitted with participant control panels, optionally, along with a set of interactive instruments for creating and obtaining discussion associated content. The discussion toolkit module may be functionally connected, as shown in the figure, to a facilitator interface, to the other components/modules included in the Virtual Environment Deployment Engine and/or to corresponding modules of the Communication Control Module.

(2) A participant database access/control module, allowing a discussion facilitator, through a control panel(s) of the participant database access/control module, to select and relay a list of discussion participants, for example, in the form of a users' database parametric statistics sampling(s), wherein the sampled parameters are to represent the participants' personal characteristics relevant in terms of discussion goal and/or associated therewith.

(3) An analysis module, allowing a discussion facilitator, through a control panel(s) of the analysis module, to select and relay discussion-parameters to be registered and analyzed in the course of the discussion, wherein analysis parameters may, for example, include: (a) the number of stickers and posts created by each discussant/participant and/or estimation marks used in every discussion thread; (b) time intervals for applying accessible content acquisition and creation tools as well as audio and video broadcasting tools by each participant; and/or (c) external-source imported data parameters concerning each discussion participant.

(4) A content acquisition and formation toolkit allowing a discussion facilitator, through a control panel(s) of the content acquisition and formation toolkit, to select and relay characteristics associated with the acquisition and formation of content (e.g. for subsequent discussion dispute).

(5) An access rights assignment/management module to distribute and/or allocate virtual environment space(s)/screen(s)/discussion-groups access rights corresponding to the statuses of discussion participants and/or access rights allocated to participants with different statuses in accordance with the rules/templates in effect.

And, (6) a procedure regulation module allowing a discussion facilitator, through a control panel(s) of the procedure regulation module, to select and relay an established order of actions for the participants, in conformity with their assigned role statuses.

The Communication Control Module, is shown to include, or be functionally associated with, the following sub components/modules:

(1) An audio and video transmission/broadcasting/multicasting module, functionally associated/networked with the content acquisition and formation toolkit, for transmitting and presenting to discussion participants, or to participants of given group(s) or interactivity environment space(s)/screen(s) of the discussion, content items associated with the discussion acquired/retrieved and/or formed/generated by the content acquisition and formation toolkit.

(2) A participant notification module, functionally associated/networked with the access rights assignment/management module, to automatically notify one or more potential discussion participants, designated within the given discussion roadmap/structure/algorithm, of an invitation to participate in at least part of the discussion journey through at least one of the virtual communication interactivity environments.

According to some embodiments, the system may generate and/or receive a facilitator designed (e.g. based on multiple selections made) path for achieving the goal of the discussion through the setting of key discussion parameters in a way that may lead to: a synergic effect, possible utilization of innovative tools, with conventional tools, such as: a chat, forum, videoconference, or whiteboard. Customizable methods may facilitate the achievement of the aspired results and the discussion goal, while automatically applying various collaboration techniques.

According to some embodiments, the system may receive a facilitator selected/designed online discussion key parameters such as: format, algorithm, structure, role-based statuses of participants, interactive tools for obtaining and creating content, and a discussion toolkit that may include verbal and non-verbal means such as predetermined stickers and tokens, their shapes, contents, colors and their potential hierarchies and the prospects of future time development of these hierarchies. These may be based on online discussion goal, number of participants, their working schedules and/or respective time zones, and/or their personal characteristics.

According to some embodiments, four basic online discussion formats may be applied in the exemplary system executed method: free discussion, directed discussion, multistage discussion, and composite discussion. Thus, in case of a significant difference in time zones and discrepancies in participants' working schedules, it may prove appropriate to hold asynchronous discussions in the formats of directed discussion and multistage directed discussion (for a large number of participants) without video broadcasting. If a synchronous interaction between participants is applicable at definite periods of time, the variants of composite discussion formats: collanar, debate, practicum, and combination may prove most efficient.

In accordance with a chosen format, the system may receive facilitator selected discussion algorithms which may implement both: the mental models of attaining the discussion goal and which are based on the discussion content cooperatively received or created depending on the discussion format; and the set of parameters for discussion portraying of participants and their future scoring. The discussion portraits and the scoring based on them may be more important for a discussion with an initially high number of participants. At the planning phase of the discussion the particular kinds of non-verbal means, such as stickers and tokens, are prepared and designed, as well as the key criteria for the further role assigning to participants and preliminary design of the discussion desk and particular discussion fields. Thus, the particular realization of hierarchies between discussion fields and non-verbal means may be planned at the Planning Phase.

For example:

in the Directed Discussion format, the suitable algorithms may be: reflection of experience, clarification of positions, approximation of positions, polemics, making decisions, examining, planning future, case solution in groups with intendedly changeable membership;
in the Composite Discussion/Collanar format, the suitable algorithms may be those of directed discussion in groups with interval inclusions of broadcasted video messages;
in the Composite Discussion/Collanar/Debates format, the algorithms applied may be those of directed discussion in groups with interval inclusion of broadcasted video messages, and specific stages of the “debate”, “dispute”, and “management contest” algorithms;
in the Composite Discussion/Collanar/Practicum format, the algorithms applied may be those of directed group discussion on training cases solution with interval inclusion of specific algorithm stages such as e-learning, video courses, project session, as well as of video messages broadcast stages; and/or
in the Composite Discussion/Collanar/Combination format, the algorithms applied may be those of specific, optionally known in the art, directed discussions such as: World Cafe, Open Space Technology, Dynamic Facilitation, and Real Time Strategic Change; with a possible combination for interval inclusion of video messages broadcast stages.

According to some embodiments, each algorithm may consist of a series of stages—discussion threads. For example:

Stages of a rational decision making algorithm stages: describing problem symptoms, problem identification, formulating goal and criteria of its attainment, generating alternative solutions, expert appraisal, and selecting a variant of solution;
Stages of a collective experience reflection algorithm: experience reconstruction, experience analysis, and developing new activity norms.

According to some embodiments, a discussion structure may be formed from unordered or ordered discussion thread complexes distributed over discussion stages in dependence on the given discussion format and algorithm. According to some embodiments, discussion structure may be changed, at every stage.

A large-scale discussion intended for large number of participants may be structured as a succession of stages. In such cases the number of thread complexes may be equal to the number of groups simultaneously participating in the discussion on each stage, wherein the quantity, order, and titles of threads in a complex are determined by a particular algorithm applied at each stage. The number of groups and the number of participants may decrease in the process of discussion. The selection of participants that continue to participate in the discussion may depend on their acquired scoring that is based on the discussion portraits.

As part of implementing the scheduled discussion algorithms, the facilitator may cast roles to the participants, which casted roles may be self-selected by the participants or assigned to them, wherein the roles imply different functions and responsibilities within the discussion process. For example, the roles of a generator of ideas and an estimator of ideas do not require access rights reallocation. Furthermore, the facilitator may design and relay to the system a range of participant statuses with corresponding access rights, which may, for example, comprise the following:

“audience member” with the assigned rights of access to review a limited scope of discussion content;
“observer” with the assigned rights of access to comment on a limited scope of discussion content;
“participant” with the assigned rights of access to a personal toolkit for discussion and content acquisition and creation;
“expert” with the assigned rights of access to operative management of scheduling the use of the toolkit for acquisition and creation of a content for a limited number of participants;
“consultant” with the assigned rights of access to video broadcasting accessible for a limited number of participants;
“master” with the assigned rights of access to video broadcasting accessible for all participants;
“speaker” with the assigned rights of access to operative management of scheduling conduct of a limited scope of discussions;
“debater” with the assigned rights of access to video broadcasting of a limited scope of debate;
“debater's assistant” with the assigned rights of access to limited management of debate regulation; and/or
“arbiter” with the assigned rights of access to the instrument of estimating a limited scope of debate.

Each participant may be assigned several role-based statuses. For example:

the “collective decision making” discussion algorithm provides for the statuses of “participant” and “expert”;
the “collanar” discussion algorithm provides for the statuses of “master”, “expert”, “consultant”, and “participant”; and/or
the “debates” discussion algorithm provides for the statuses of “debater”, “speaker”, “arbiter”, “expert”, and “observer”.

In conformity with preplanned discussion algorithms, facilitator selections of instruments for obtaining and creating content for further discussion, may be relayed to the system's server(s). The selected instruments for obtaining and creating content, may be selected from among a selection of at least: textual, visual, audio and video materials, audio and video broadcasts, text and graphics creation tools, techniques of problem formulation, computation, analysis instruments, planning instruments, discussion tools—in particular, sets of functional types of movable bilateral roll-up stickers and tokens with a modal window, a changeable set of estimation marks, information boards of analyzed parameter condition, catalog-selected templates of or facilitator-created text boxes, visual objects and spatial areas of the content, forms and layouts to guide the participants' interaction in the order corresponding to the selected discussion format and algorithm.

According to some embodiments, the sets of sticker functional types may comprise at least the following sticker types: information stickers which contain only facilitator messages, open stickers (personal or anonymous) for free information exchange, confidential stickers (personal or anonymous) accessible only to a limited circle of participants, conditioned stickers—available only if facilitator's condition is fulfilled and/or if the acquired score of participant is high enough. Thus, the hierarchies of such non-verbal means as stickers, the hierarchy of participants and the correspondence between them may be planned in addition to the hierarchy of the discussion sub-fields.

### (2) Preparation Phase

According to some embodiments, as part of the preparation phase, the system may receive facilitator commands/, instructions and/or selections, from control panels interface(s) of at least the following selection of system, software and/or hardware implemented, modules:

discussion toolkit module;
procedure regulation module;
participants' database module,
access rights assignment module; and
analysis module.

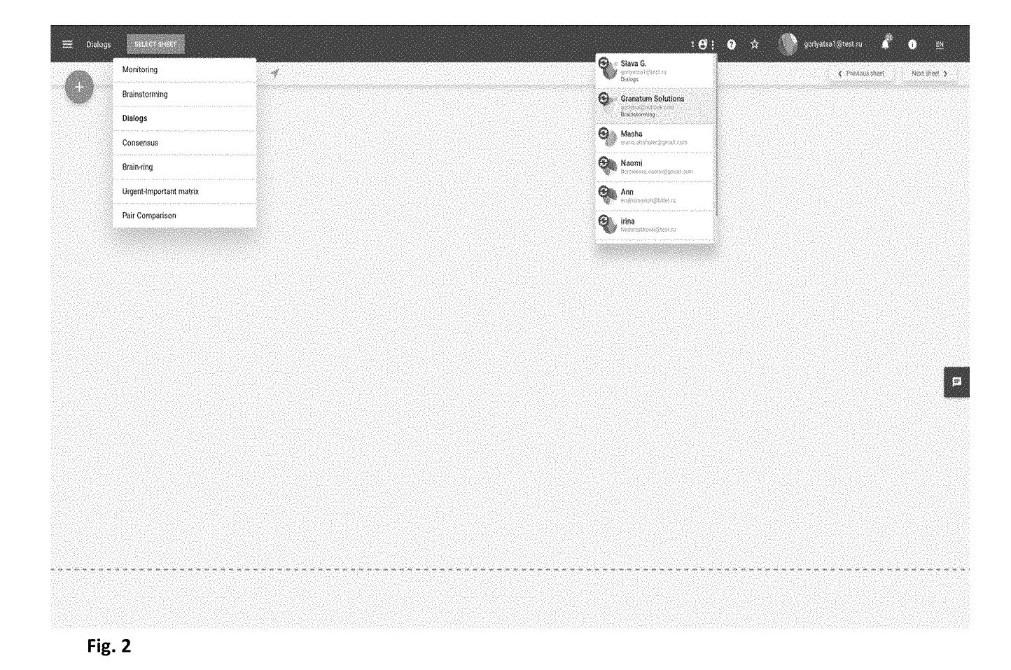

In FIG. 2 there is shown, a screenshot of an exemplary discussion conduct toolkit interface and control panels thereof, in accordance with some embodiments of the present invention.

According to some embodiments, by employing the discussion toolkit module control panel, the facilitator may provide a discussion thread structure designed in a preceding phase. Each discussion thread may be represented simultaneously on website and user's mobile application interfaces on some or all of the participants' displays, as a field/screen outfitted with participant control panels, with a set of interactive instruments for creating and obtaining content, an audio and video toolkit and a discussion toolkit.

In the upper left part of the figure, there is shown a dropdown ‘Select Sheet’ menu for interfacing user selection of templates based interactivity environments, in accordance with some embodiments of the present invention. In the upper right part of the figure, there is shown a dropdown menu listing users participating in discussions which are also associated with the user (e.g. user is a participant of) interfacing the discussion conduct toolkit.

By employing the control panels of a procedure regulation module, the facilitator may establish an order of actions for the participants, in conformity with their assigned role statuses.

If the free discussion format is selected, the facilitator may assign the participants' access rights to create discussion threads represented in the form of fields/screens with text boxes, visual objects, and spatial areas—rendered based on one or more templates chosen by the participants/facilitator, optionally without reference to other discussion threads.

If the directed discussion format is selected, the facilitator may design a structure of discussion as a regular complex of discussion threads, represented in the form of fields/screens with text boxes, visual objects, and space areas interconnected with the fields of the previous and subsequent discussion threads, the discussion threads being arranged in a sequence determined by the algorithm selected.

If the multistage directed discussion format is selected, the facilitator may provide a ranked multistage structure of a discussion in the form of a suite of thread complexes consisting of a sequence of stages, which suite, on its first stage, contains N copies of thread complexes corresponding to the number of groups of the first-stage discussion participants and which suite, in the process of proceeding to the following stages, contains a number of thread complex copies decreasing thus, that the number of groups and copies of threads at a stage i equals to:

Nᵢ=(Xᵢ₋₁)*(Nᵢ₋₁/Yᵢ₋₁)/Yᵢ

Where Y is the number of participants in a group, and X is the quantity of the group representatives to participate in the discussion on the next stage. The facilitator may provide at each discussion stage, in each copy of thread complexes, the last thread which is completed, by selecting X representatives from each group of Y participants to take part in the next-step discussion within mixed groups of representatives, optionally, also changing the status of the participants who were not selected at any discussion stage as their group representatives, to the “observer” status.

At each stage, all the parameters N, X, Y in the equation above may be chosen in such a way that at the following stages they stay integers. Eventually at the final stage of the discussion N(final)=1, and each stage X is less or equal to Y. The selection of participants to take part in the next-step discussion depends on their acquired scoring that is based on the participant discussion portrait.

According to some embodiments, a participant discussion portrait may act as a tool for participants selection. The discussion portrait of a participant may include such parameters as: (1) timing of the entrance to the session and the exit from the session and/or to/from the certain discussion field, (2) timing when certain type of verbal statement was made, when certain kind of stickers and/or tokens were used, positioned, repositioned and/or removed; (3) time intervals needed to create/delete certain stickers or tokens and/or to make certain verbal statements; (4) usage of widgets: viewing videos, presentations; (5) verbal activities such as broadcasting in the panel and/or making posts in the chat sessions; (6) passing tests, formal test scores, etc. Based on the 6 exemplary above data, the discussion portrait of each participant may be monitored in the course of the entire discussion. It includes combined parameters such as, for instance, the activity index, i.e. the number of events of a certain type created by the user for a certain time interval and the reciprocity index, i.e. the ratio of the created estimates and comments to the received estimates and comments. In addition to the above, the discussion portrait of a participant may also include reports on past stages of the discussion with printout of all stickers, tokens, comments, estimates, their creation time, their placement area, design, timing, etc. An acquired scoring of participant may be a function solely, or partially, based/calculated-based on his discussion portrait.

If the collanar composite discussion format is selected, the facilitator may provide an ordered structure of a directed discussion in the form of a suite of discussion thread complexes in a quantity corresponding to the number of discussion participant groups and at least one discussion thread common for all complexes, which includes at least one video broadcast session available to all participants; and optionally assigns “master” status and the relevant access rights to at least one participant.

If the debate composite discussion format is selected, the facilitator may provide, within the ordered structure of the suite of discussion thread complexes, a thread common for all complexes, which contains at least two video broadcasts available to all participants; and optionally assigns “debater” status to at least two participants, “debater assistant” status to two participants and the “speaker”, “arbiter”, and “master” statuses, respectively, to at least one participant; may optionally distribute access rights corresponding to the statuses of “observer” and “audience” among the rest of the participants; and may optionally allocate access rights to participants with different statuses in accordance with the rules/templates in effect.

If the practicum composite discussion format is selected, the facilitator may provide, within the ordered structure of the suite of discussion thread complexes, a collanar pertinent to the directed discussion format and at least one thread, common for all complexes, which includes at least one interactive instrument for obtaining and creating content; and may optionally assign the “master” and “expert” statuses with the accompanying access rights each to at least one participant according to the rules/templates in effect.

If the combination composite discussion format is selected, the facilitator may provide an ordered structure of a directed discussion thread complex suite, each complex containing at least one thread which comprises at least one video broadcasting session accessible for all participants, one video broadcasting and one interactive instrument of content acquisition and creation, which are accessible only to the participants of a limited number of groups; and mat optionally assign the statuses of: “leader”, “expert”, “consultant” and “master” with the corresponding regulated access rights, to at least one participant according to the rules/templates in effect.

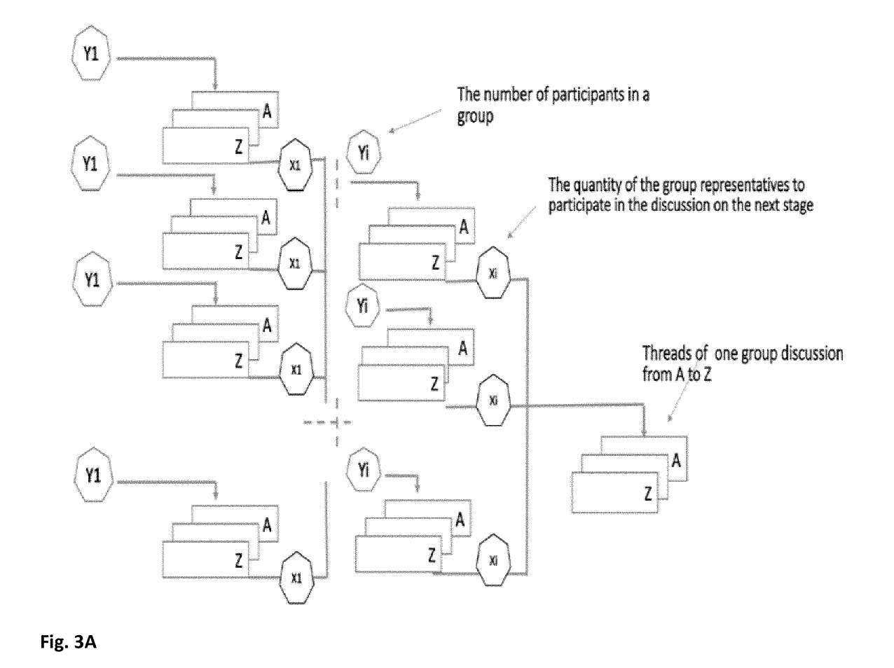

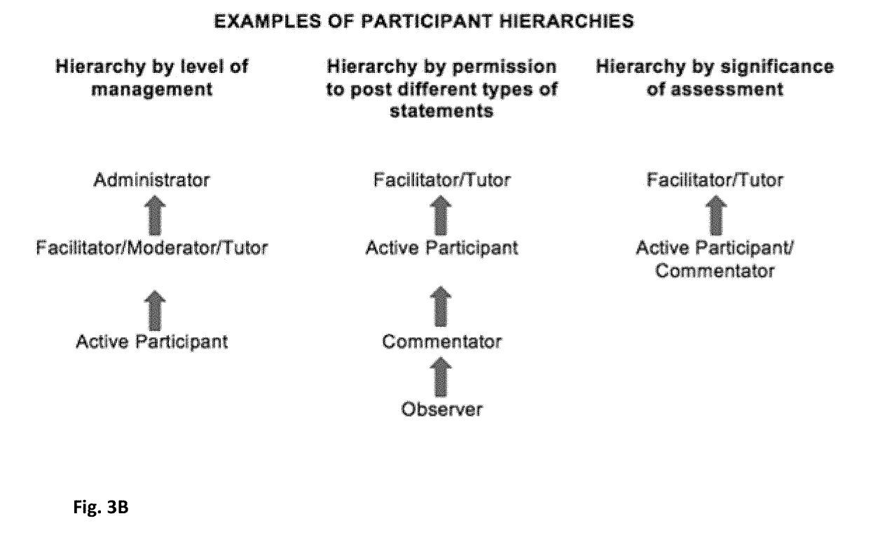

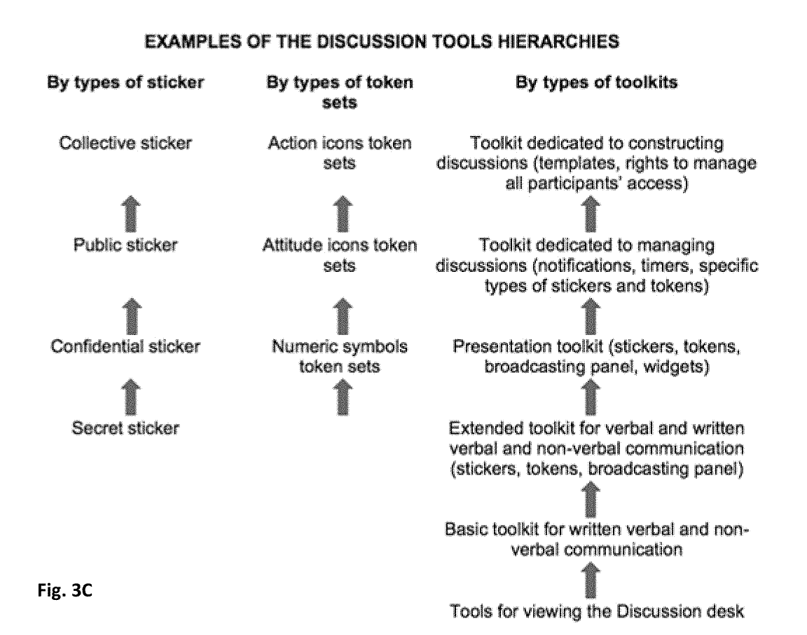

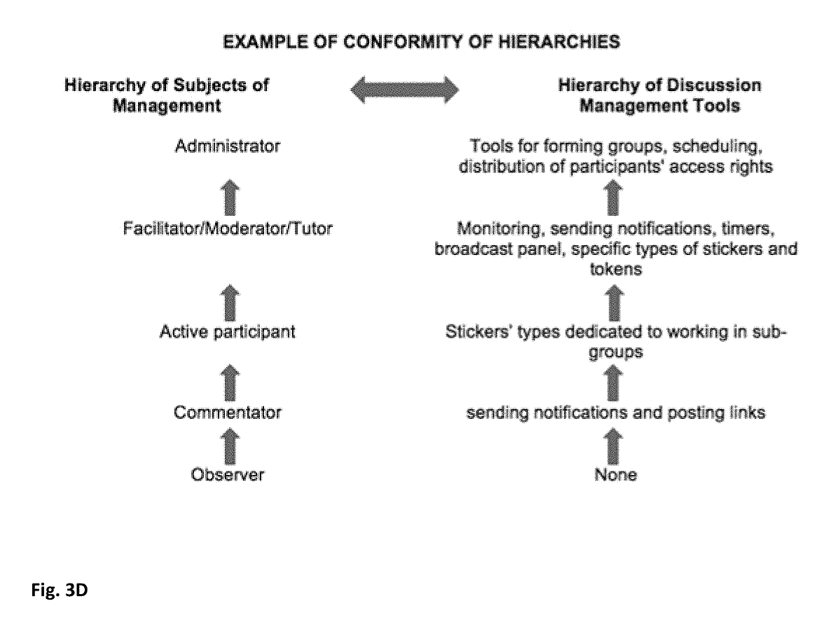

In FIG. 3A there is shown, a diagram depicting a participant groups dynamics based structure, of an exemplary system facilitated discussion, as part of a journey through a system generated interactivity environment, in accordance with some embodiments of the present invention.

According to some embodiments of the present invention, methods of virtual discussion management and systems for facilitating such discussions, may be essentially based on virtual presence of participants. The systems and methods described herein may be at least partially based on sets of rules, means, tools and embedded hierarchies.

In FIG. 3B, there is shown a set of diagrams of exemplary participant hierarchies, of an exemplary system facilitated discussion, utilized as part of a journey through a system generated interactivity environment, in accordance with some embodiments of the present invention.

In the figure there are shown: (1) Management level hierarchies, including: (a) an active participant hierarchy level, that may have no administrative rights; (b) a facilitator/moderator/tutor hierarchy level and (c) an author of facilitation hierarchy level, both having limited set of administrative rights; and (d) an administrator hierarchy level having all administrative rights in the discussion. (2) Discussion thoughts and statements addition rights hierarchy, including: (a) an observer that may not add his thoughts or statements to the discussion; (b) a commentator that may only react on thoughts or statements added by others; (c) an active participant that may add his own thoughts or statements and react to thoughts or statements made by other participants; and (d) facilitator/tutor having all thoughts or statements addition rights, optionally, including the allocation and withdrawal of such rights to/from others. (3) Estimation importance hierarchy, including (a) a commentator, whose estimations are regarded as less important (e.g. given a lower weight in the discussion); and (b) a facilitator, whose estimations are regarded as more important (e.g. given a higher weight in the discussion).

A virtual discussion, in accordance with some embodiments of the present invention, may be based on a combination of verbal and nonverbal ways of transferring information, as is the case with real-life non-virtual discussion. A system, in accordance with some embodiments, may include means such as: visual communication, audible communication and the exchange of text messages and files of different formats, these may be enriched by a “discussion desk”. The “discussion desk” may include discussion fields arranged such that specific discussion fields have/correspond-to different destinations. Specific discussion fields may contain information on one or more of the following: ideas, reactions of participants, plans of participants, participant actions, and participant given scores. These fields, or areas, may differ from each other based on their contained information, their contained information history and/or based on their importance, their urgency, or the like.

Examples of areas/fields, include: the Service area of a menu providing the choice of such means/tools as Stickers (where the statements can be presented), Doings (containing predetermined reactions and the claim of possible actions), etc.; a chats area; a widgets area, an immediate actions area, a specific topic area, etc.

According to some embodiments, the participants of a discussion can put their statements on stickers, can comment to the stickers of other participants, can put their stickers in various fields of the discussion desk, can put various Doings that they have chosen and append them to the stickers of others, can share their scores of certain actions, etc. Particular participants may have an access only to certain groups of non-verbal means, tokens and stickers, and to certain discussion sub-fields, thus maintaining a consistency between the hierarchies of participants, non-verbal means, and sub-fields.

According to some embodiments, the participants of a discussion can participate in chats in the designated chat areas and may generate audio/video records of their statements and put them in a corresponding area of the discussion desk. By doing so, they may combine verbal (stickers, records, comments, etc.) means of communication with nonverbal ones. The nonverbal information may be presented graphically by positioning the stickers in certain areas, choosing the shape and/or colors of stickers, choosing the doings, etc.

The combined presentation of both verbal and nonverbal means of communication may be applicable when simultaneous presence of participants is not possible, as it may be entirely, or partially, based on their virtual presence. Accordingly, the discussion desk may contain information of: the current state of the discussion, the history of the discussion and/or of both.

According to some embodiments, a built-in hierarchy of reactions may be inherited and applied to the following structure and flow of the discussion based on: comments made on stickers through general statements, selection/usage of specific types of stickers, the selected positioning of stickers in particular fields of the discussion desk, the marking/tagging of stickers as “good”, “bad”, “urgent”, “important”, etc. The inherited hierarchy may thus combine verbal (e.g. statements) and non-verbal (type, position, properties, tagging, time of positioning, time taken to position—stickers) communication channels, that is graphically rendered and established on the displays of some or all of the discussion participating users.

In FIG. 3C, there is shown a set of diagrams of exemplary access privilege hierarchies, along with their corresponding Sticker tools usage hierarchies and token tools setting hierarchies, of an exemplary system facilitated discussion, as part of a journey through a system generated interactivity environment, in accordance with some embodiments of the present invention.

In the figure there are shown Access privileges hierarchies, including: (a) Access privileges to discussion deck browsing/viewing; (b) Access privileges to discussion deck browsing and commenting to some type of stickers (c) Access privileges to discussion deck browsing, commenting and creating of some type of stickers; (d) Access privileges to discussion deck browsing, commenting and creating of some type of stickers and to appointing other participant group roles with access privileges; (e) Access privileges to create content of the discussion deck; and (f) Access privileges to discussion deck browsing, commenting and creating of some types of stickers and the appointing of an Author of facilitation, facilitator/moderator/tutor and/or other participants—with their access privileges.

Further shown in the figure are tools access and utilization hierarchies corresponding to some of the above listed access privileges. Shown estimation token set hierarchies, respectfully corresponding to Access privileges hierarchies (d), (e) and (f) above, include: (a) Setting of token with symbols of numeral; (b) Setting of token with symbols of attitude; and (c) Setting of token with symbols of doings. Shown sticker's openness and transparency hierarchies, respectfully corresponding to Access privileges hierarchies (c), (d), (e) and (f) above, include: (a) a secret sticker; (b) a confidential sticker; (c) an open sticker; and (d) public sticker.

FIG. 3D there is shown a set of diagrams of exemplary subject/participant/role hierarchy and its corresponding tools control hierarchy, of an exemplary system facilitated discussion, as part of a journey through a system generated interactivity environment, in accordance with some embodiments of the present invention.

In the figure, there are shown the following subject/participant hierarchies: (a) an observer; (b) a commenter; (c) an active participant; (d) a facilitator/moderator/tutor; and (e) an administrator. Corresponding control tools hierarchies, respectfully include: (a) none—no access privileges to control tools; (b) sending notifications and posting links—tools to comment of some type of stickers and notify participants; (c) stickers' type dedicated to work in specific sub-groups—specific tools to create of some type of stickers, invite some participants to take a part and notify participants; (d) discussion monitoring—tools for sending notifications, timers, access to broadcast panel, specific types of stickers and tokens; and (e) administrator tools—tools for forming groups, scheduling, distribution of participants' access rights, tools to appoint of participant group roles with access privileges, give a task and notify participants, tools to create a content of the discussion desk and optionally, tools to appoint of Author of facilitation, facilitator/moderator/tutor, other participants with their access privileges.

According to some embodiments, using the analysis module control panel, the facilitator may set discussion parameters to be relayed, registered and analyzed in the course of the discussion, wherein analysis parameters may include, at least: (1) the number of stickers and posts created by each discussant/participant and/or estimation marks used in every discussion thread; (2) time intervals for applying accessible content acquisition and creation tools as well as audio and video broadcasting tools by each participant; and/or (3) external-source imported data parameters concerning each participant.

According to some embodiments, using the participants' database module access/control panel, the facilitator may draw up a list of the discussion participants in the form of a users' database parametric statistics sampling(s), wherein the sampled parameters are to represent the participants' personal characteristics relevant in terms of discussion goal and/or associated therewith.

For example:

For studying collective experience, relevant information is personal data on a place of employment, job position, employment time record, age, profession, achievements, etc.;
For making a collective decision on how to meet a challenge, relevant information on personal characteristics may comprise education, profession, previous experience of participation in similar sessions, and participation in implementation of resulting decisions.

The facilitator may organize the participants in groups based on conformance of participants' individual traits to the selected role-based statuses, wherein the facilitator may cast groups by random sampling from a list of candidates with personal qualities required for each thread of the discussion structure in the order corresponding to the discussion format and algorithm, thus, making the working groups ‘provisional’.

For example, the collective decision making discussion algorithm may provide only for the role statuses of “participant” and “expert”, therefore, demanding the 50/50 gender ratio for maintaining positive group dynamics, 90% of participants with similar level of work positions in order to achieve a high level of confidence, and 10% of participants with a higher level of work positions and length of experience in order to achieve qualitative discussion results.

According to some embodiments, using the access right assignment module control panel, the facilitator may allot corresponding access rights to the participants.

### (3) Discussion Phase

According to some embodiments, as part of preparation and management of a discussion, the facilitator may be provided with access to at least the following selection of module control panels: a discussion toolkit, an interactive components for obtaining and creating content, audio and video broadcasting tools, procedure management tools, participants' databases, access right assignment components and/or an analysis toolkit.

The facilitator may carry out the operative management of the discussion's successive stages by rearranging groups for work in each of the discussion threads according to the requirements of the discussion algorithm stages, while taking into consideration participants' personal characteristics.

For example, at least 40% of group participants should have experience in participation in other “provisional” workgroups at a preceding stage, in order to enable efficient information exchange between the groups.

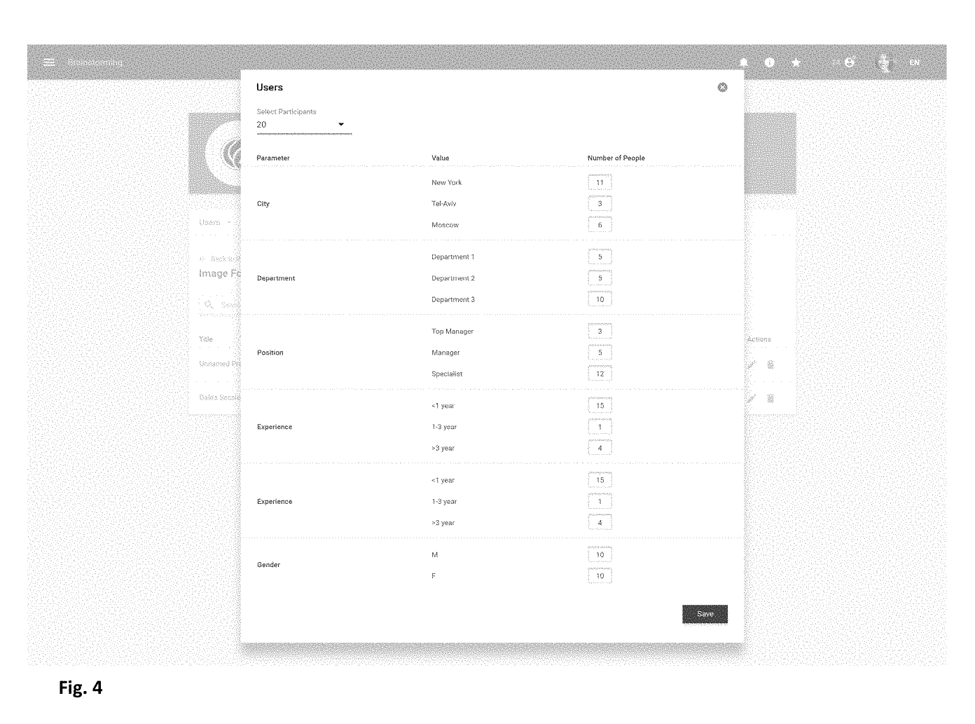

In FIG. 4 there is shown, a screenshot table depicting participant groups mix and forming dynamics, of an exemplary system facilitated discussion, as part of a journey through a system generated interactivity environment, in accordance with some embodiments of the present invention, wherein, participant types and parameters are shown. Potential participants are divided/clustered into specific values of common parameters: City—New-York, Tel-Aviv, or Moscow; Department—1, 2, or 3; Position—Top manager, Manager, or Specialist; Experience—<1, 1-3, or >3 years; and Gender—Male or Female. The discussion administrator/facilitator may select participants for the discussion from within the table.

According to some embodiments, using the display of a computerized device running a web application and/or a client application, the facilitator may monitor the interaction(s) between participants in different groups in various discussion threads and responsively administer their activities by displaying information boards with analytical data on personal and group work results. The information boards may be visible to all or to a limited circle of participants, consistent with time dependence correspondence between the hierarchies of participants and the hierarchy of verbal-non-verbal tools, and may also be utilized for distributing notifications, comments and/or remarks among the participants, within the course of audio and/or video broadcasting/presentation.

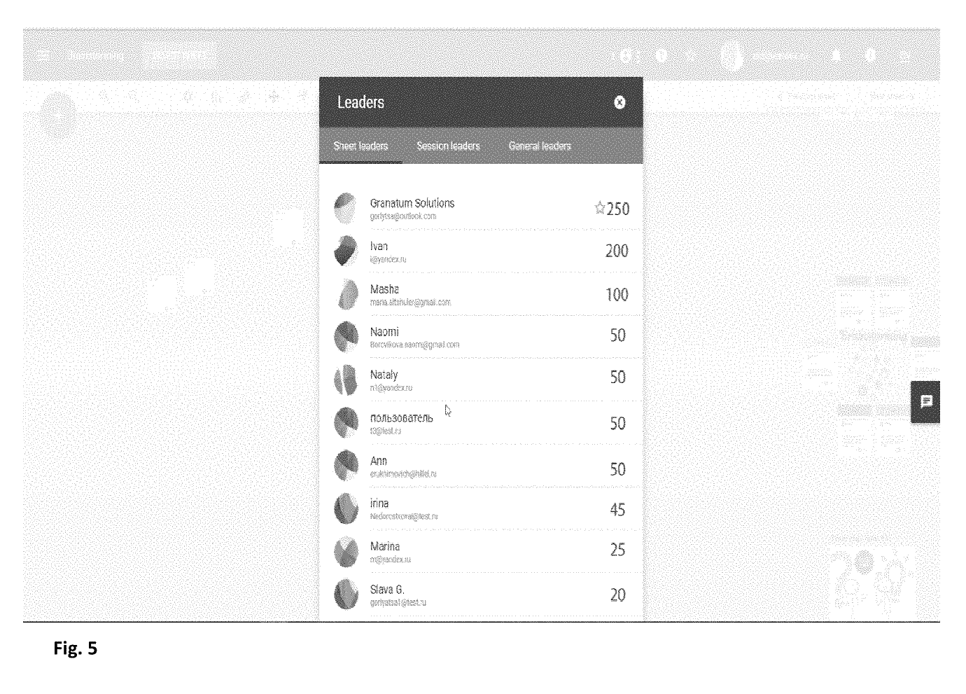

In FIG. 5 there is shown, a screenshot of an exemplary information board presenting analytical data relating to work results of a participant discussion group, in accordance with some embodiments of the present invention. In the figure, Sheet, Session and General leaders are presented along with their respective current scorings.

According to some embodiments, participants, purposefully united in task-oriented groups, may conduct a directed discussion on the basis of one or more content item(s) jointly received or created by them according to a discussion format and following to a discussion algorithm. They may go from thread to thread within the framework of a mental model of goal achievement.

Inside each thread, the participants may debate within the group team, optionally producing movable bilateral roll-up stickers with a text on their faces indicating discussion topic proposed by a given participant and a modal window on the back (reverse) side of the sticker for posting text messages, visual images, estimation marks, and other objects.

The participants may position their stickers in allocated areas and thereby may designate the type of relations between the discussion topics, subsequently, as the relevance or the type of inter-topic relations varies during the course of the discussion, the participants may reposition their stickers.

For example, provided that the discussion goal is generating cooperative solution for a problem, the selected format may be directed discussion and the algorithm may be rational decision making, then, on the stage of selection from the proposed alternatives under discussion, in the discussion thread interface, within the discussion field/screen plane, four space areas may be allocated as the quadrants [1]- [4] made of two perpendicularly intersecting axes, wherein each axis represents a certain interval of one of the characteristics of the discussed proposal. Each quadrant may be intended for stickers expressing opinions on proposed alternatives featuring characteristics (1) and/or (2); further on, while posting in order to clarify proposed alternatives and to comment on them, the participants may reposition their stickers within the matrix quadrants to indicate how the discussed alternative proposals interrelate in the two-dimensional space of these situational characteristics, thereby working towards and generating a cooperative solution.

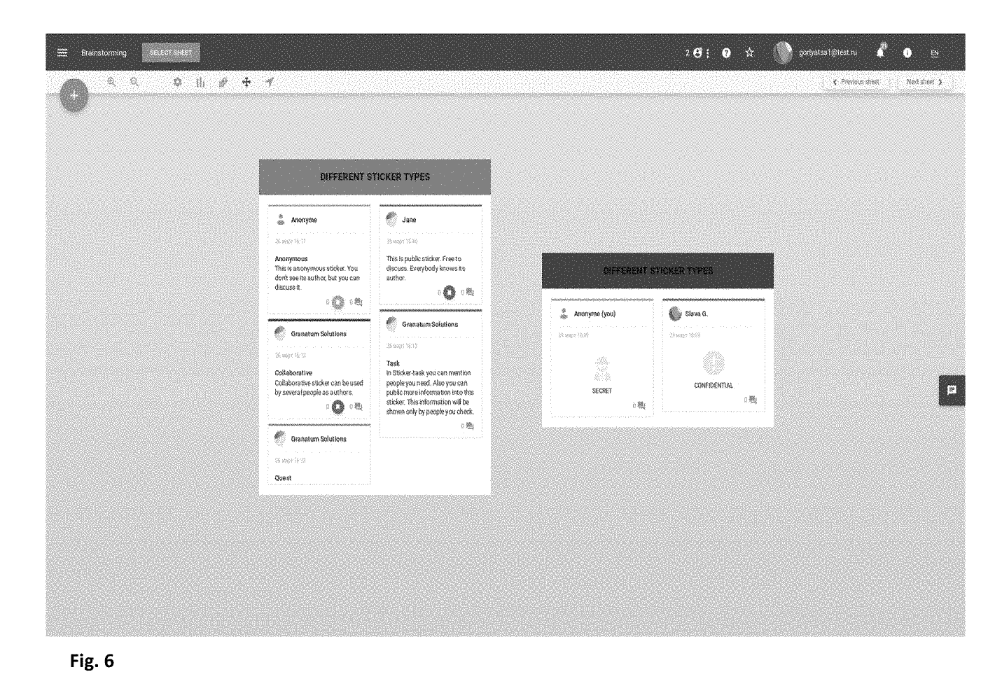

In FIG. 6 there is shown, a screenshot of an exemplary discussion field/space/screen, including and/or used for the managing of, or interfacing with, different types of stickers including text input fields, which stickers are assigned to and owned by a specific participant(s) in, or an originator of and/or a moderator, of the discussion, having access to the exemplary discussion field/space/screen, in accordance with some embodiments of the present invention. On the left side there is shown a designated area/zone including: Anonymous, Public, Collaborative, Task and Quest stickers positioned by participants; on the right side there is shown a designated area/zone including: an Anonymous sticker positioned by the user himself and a confidential sticker positioned by another participant.

According to some embodiments, the participants may use content acquisition and creation tools for discussion from a selection of at least: textual, visual, audio and video materials, audio and video broadcasts, text and graphics creation tools, problem formulation tools, computation, analysis, and planning in the time intervals determined by the chosen discussion format in compliance with the statuses and access rights allocations made.

The participants may use discussion tools and collaborate with each other in discussion threads via:

statements and comments in posts allocated in open type movable stickers;
cooperation in order to obtain necessary information to fill in the conditioned-type stickers;
establishing relations and connections, comparing statements while changing sticker positions within the areas;
dramatizing, explaining, and debating on standpoints during the discussion;
evaluating statements by estimation marks;
structured consideration of the content received for discussion;
development, generation, and designing of the content for discussion;
responding to the analytical information on personal and group work displayed on the information boards;
dissemination of the information acquired earlier while moving from one group to another;
sharing responsibility for the discussion outcomes; and
choosing and accepting various roles statuses during discussion.

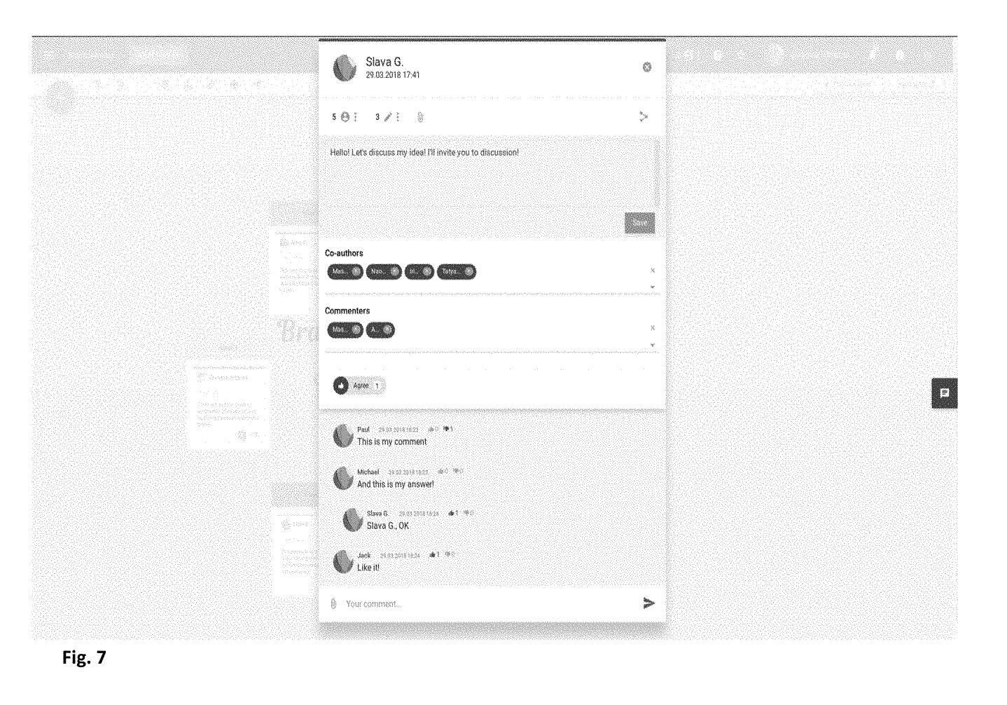

In FIG. 7 there is shown, a screenshot of an exemplary space/screen including a sticker with one or more text input fields. In the figure the sticker is shown to include: the name of its author/owner, his texting/editing window, co-authors and commenters to the sticker and the sticker-related discussion feed. The sticker may include reverse input field(s), wherein reverse input field(s) may be utilized by participants of the space/screen/sticker for locating posts in the form of text messages, visual images, estimation marks, and/or other objects, in accordance with some embodiments of the present invention.

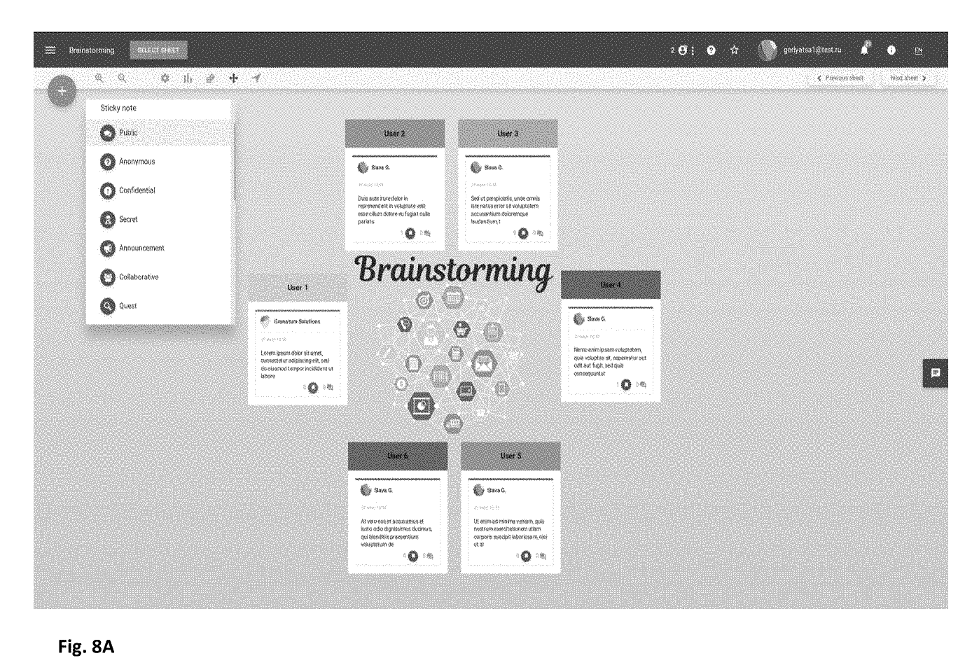

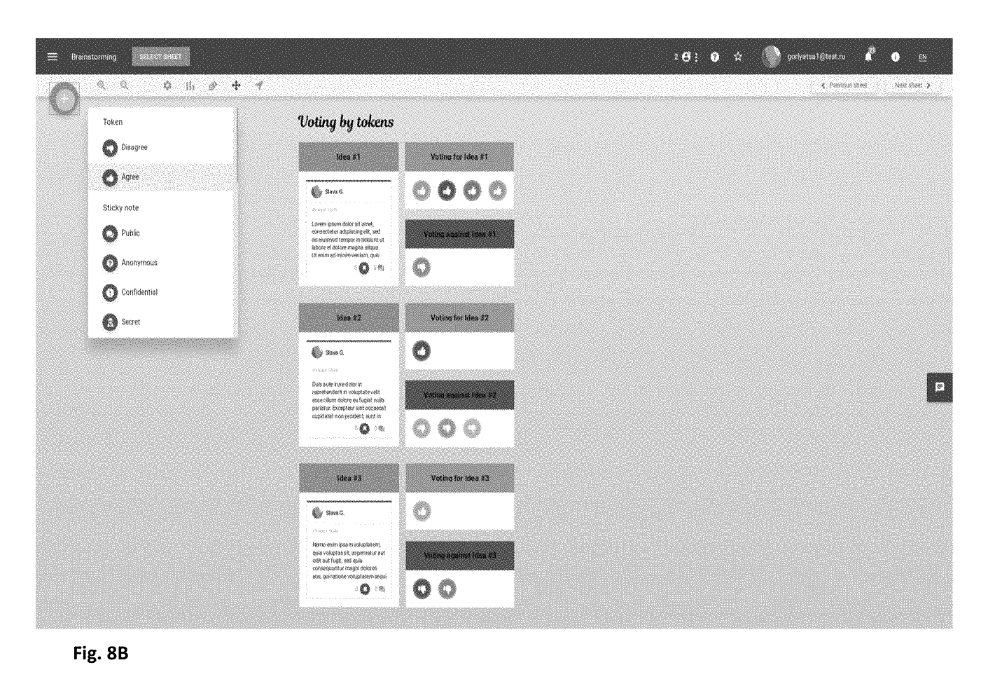

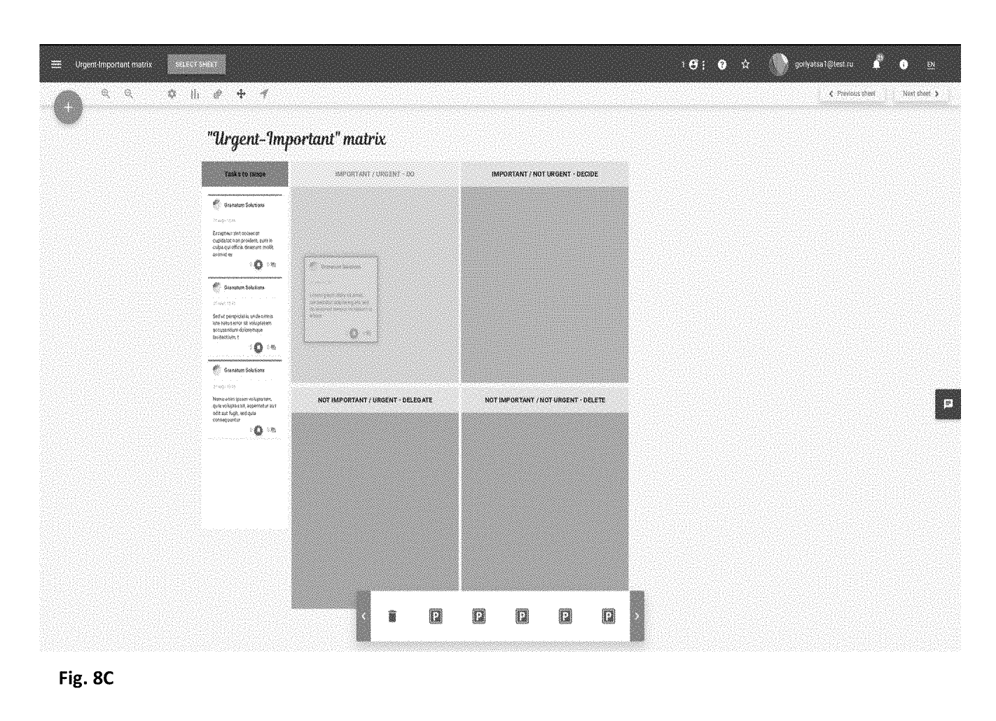

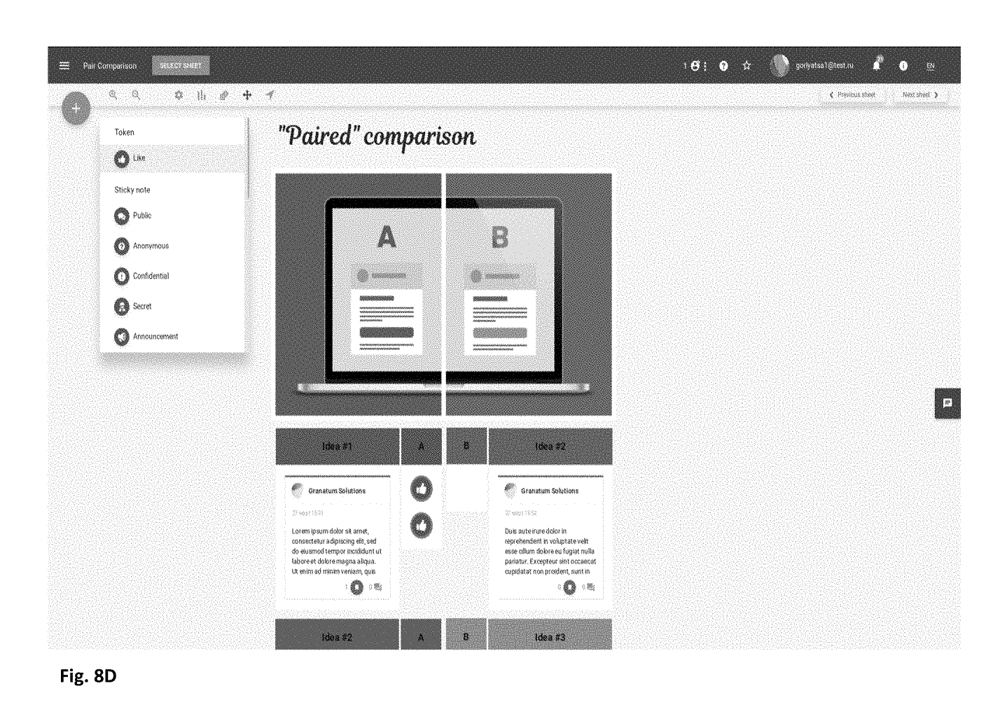

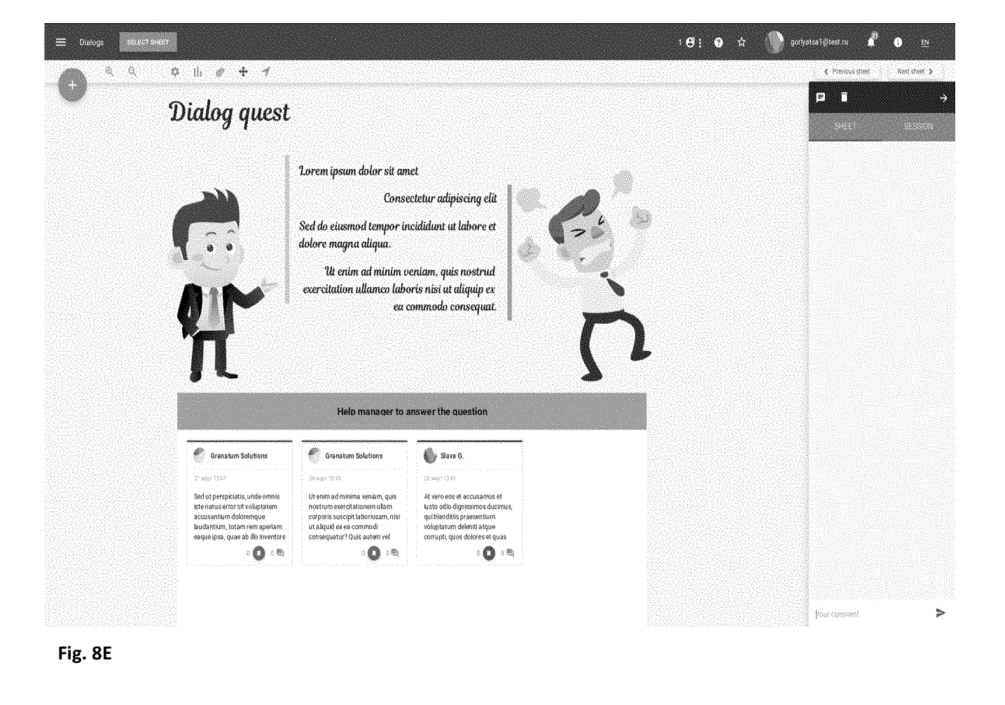

In FIGS. 8A-8E there are shown, screenshots of exemplary interactivity environment template based space/screens, in accordance with some embodiments of the present invention.

In FIG. 8A there is shown, an exemplary interactivity environment Brainstorming template.

In the exemplary figure, six participants post their stickers in designated slots. Each participant lists idea(s) in their sticker, and after a few minutes, on facilitator's cue, they may move their stickers to the next slot in a clockwise order. Now, the participants read the ideas of a preceding peer and add other ideas and/or feedback. The cycle repeats itself until each participant gets their original sticker back.

In FIG. 8B there is shown, an exemplary interactivity environment Multistage Voting template.

In the exemplary figure, stickers with ideas are placed in vacant slots/zones that have empty areas, two in this example, for voting tokens on their right (e.g. one for voting for, another one—against the idea). The number of ideas to vote for may vary indefinitely. Each idea sticker is named.

In the exemplary figure, the stickers with the proposals that are subject to comparison are posted in zones dedicated for stickers. Participants express their preferences in each pair of stickers by placing their tokens in a dedicated zone next to a chosen proposal. In the exemplary figure, the participants place their stickers in dedicated zones for stickers developing the dialogue depicted on a template.

In FIG. 8C there is shown, an exemplary interactivity environment Priorities Setting template.

In the exemplary figure, the participants post their stickers with well-reasoned proposals in a four-quadrant matrix: Important & Urgent, Important & Not Urgent, Not Important & Not Urgent, Not Important & Urgent. They can reposition their stickers based on the results of discussions in modal windows of the reverse side of their sticky note.

In FIG. 8D there is shown, an exemplary interactivity environment Paired Comparison template.

In the exemplary figure, the stickers with the proposals that are subject to comparison are posted in empty slots, and the participants express their preferences in each pair of stickers by placing their tokens on a corresponding half of a line connecting the pair under comparison.

In FIG. 8E there is shown, an exemplary interactivity environment Dialogue Opinion Collection template.

In the exemplary figure, the participants place their stickers in empty slots developing the dialogue depicted on a template.

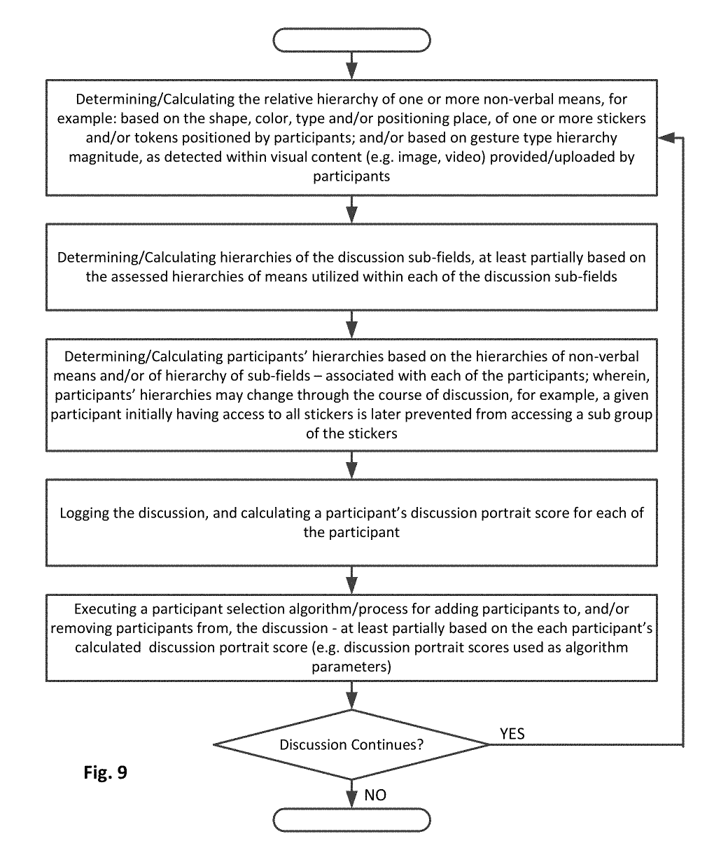

In FIG. 9 there is shown a flowchart of the main steps executed as part of an exemplary process for discussion elements hierarchies generation and discussion participants adding/removing, in accordance with some embodiments of the present invention. Shown steps include: (1) Determining/Calculating the relative hierarchy of one or more non-verbal means, for example: based on the shape, color, type and/or positioning place, of one or more stickers and/or tokens positioned by participants; and/or based on gesture type hierarchy magnitude, as detected within visual content (e.g. image, video) provided/uploaded by participants; (2) Determining/Calculating hierarchies of the discussion sub-fields, at least partially based on the assessed hierarchies of means utilized within each of the sub-fields; (3) Determining/Calculating participants' hierarchies based on the hierarchies of non-verbal means and/or of hierarchy of sub-fields—associated with each of the participants; wherein, participants' hierarchies may change through the course of discussion, for example, a given participant initially having access to all stickers is later prevented from accessing a sub group of the stickers; (4) Logging the discussion, and calculating a participant's discussion portrait score for each of the participant; and/or (5) Executing a participant selection algorithm/process for adding participants to, and/or removing participants from, the discussion—at least partially based on the each participant's calculated discussion portrait score.

According to some embodiments of the present invention, an exemplary method, implemented by a system/platform for generating and operating an online interactivity environment and for the organization and conduct of online discussions, may include any combination of the following steps and sub-processes.

According to some embodiments, the method for generating and operating an online interactivity environment and for the organization and conduct of online discussions may comprise a combination of the following steps: (1) receiving and registering a subject and goal(s) of a discussion; (2) assigning to at least one discussant/participant (e.g. the source of the subject/goal), facilitator's rights to administer information provision, representation, and exchange—through the facilitator's machine display interface with the Internet and/or local networks, by means of a control panel suite for handling/Interfacing with facilitator-oriented software modules located at the back end of the implementing system; (3) receiving and registering, facilitator relayed selections (e.g. sequential selection) of the discussion characteristics, including: the format, algorithm, structure, composition of the parameters to be collected and analyzed during the debate, discussant role-based statuses and corresponding discussion means, and/or characteristics associated with the acquisition and formation of content (e.g. for subsequent dispute);

(4) forming, based on facilitator provided parameters/instructions, a discussion structure containing and/or ‘defining the operation characteristics of’ any combination of the followings: (a) at least one discussion thread represented simultaneously on interfaces of website and/or mobile applications on some or all of the discussion participants' computerized devices and displayed, for example, in the form of a graphic user interface screen with participant personal control panels, (b) an interactive toolkit, and/or specific operation definitions thereof, for content acquisition and formation, (c) an audio and video transceiving toolkit, (d) a discussion performance toolkit, optionally including sets of functional, bilaterally movable, roll-up stickers with a modal window, estimation marks, information boards of analyzed parameters, and/or (e) catalog-selected templates, or facilitator-created text boxes, visual objects and spatial areas of the content, form, and layout to direct actions of the discussers in the order corresponding to the selected format and algorithm;

(5) enrolling users/participant, based on facilitator provided selections, by notifying selected candidates and generating a list of discussants, wherein each chosen discussant/participant is characterized by at least one individual feature;

(6) Performing successive personality oriented formation of group memberships while examining the relevance of participant(s)' personal characteristics to the requirements for the selection of participant-role statuses, which may be performed by random sampling from the list of discussers/potential-participants who satisfy the personal requirements of each discussion structural thread in the order as per the received discussion format and algorithm; assigning pertinent access rights to the discussants;

(7) intermittently receiving facilitator's instruction and executing respective operations associated with the operative management of the discussion's successive stages, by: (a) forming groups, (b) assignment and cessation of the participants' access rights to the discussion threads (e.g. following discussion groups) in accordance with the selected discussion algorithm, (c) demonstrating to all or a limited pool of the participants information boards with analytical data on individual and group work within the discussion and/or a specific thread(s) thereof, and/or (d) dispatching notifications to the participants;

(8) conducting the discussion among the participants by way of: (a) creating within some or all of the discussion thread(s), and rendering as part of one or more interactivity spaces thereof, movable bilateral roll-up stickers wherein the title of the topic of the discussion may appear on one side and a modal window of the debate held on the other side of the sticker; (b) positioning, based on debaters/participants provided inputs, their stickers within two or more spatial areas (e.g. defined within a facilitator selected discussion template and rendered as part of a discussion interactivity space(s)) to define and denote at least one type of relations between the topics of discussion; (c) locating posts from participants inside the modal windows (graphical control element subordinate to an application's main window, which creates a mode that disables the main window, but keeps it visible with the modal window as a child window in front of it) of posted stickers, including: text messages, visual images, estimation marks, and other objects; (d) repositioning, based on debaters/participants provided inputs, their stickers in the event that in the process of discussion the significance or type of relations between the topics were changed/varied; and/or (9) receiving and/or forming content for dispute and participation in video transmission in the time intervals determined by the selected discussion format.

According to some embodiments, the method for generating and operating an online interactivity environment and for the organization and conduct of online discussions may further comprise software modules for implementation of said method, including at least: (1) a participants' data base module, (2) an access rights management/assignment module, (3) a knowledge base module—an archive, (4) an analysis module, (5) a discussion conduct toolkit module, (6) a content acquisition and formation interactive elements module, and/or (7) an audio and video transmission means module.

According to some embodiments, the method for generating and operating an online interactivity environment and for the organization and conduct of online discussions may further comprise analyzing various parameters in the course of a given discussion, wherein parameters may, for example, include: (1) the number of stickers and posts created by each discussant/participant; (2) estimation marks used within discussion threads; (3) timestamps and intervals of accessing/applying (e.g. by each participant) the accessible content acquisition and creation tools and/or the audio and video transmission means made available for the discussion/thread; and/or (4) data concerning each discussant—imported from external sources.

According to some embodiments, the method for generating and operating an online interactivity environment and for the organization and conduct of online discussions may further comprise the selection of role-based statuses, with corresponding access rights, wherein statuses may comprise, any combination of, at least the following status types: (1) “audience participant” status assigned the rights of access to reviewing a limited scope of discussion content; (2) “observer participant” status assigned the rights of access to comment on a limited scope of discussion content; (3) “participant” status assigned the rights of access to a personal toolkit for discussion conduct, and content acquisition and creation; (4) “expert” status assigned the rights of access to operative management of scheduling the use of the toolkit for acquisition and creation of a content of a limited membership; (5) “consultant” status assigned the rights of access to perform video transmission accessible for a limited membership; (6) “master” status assigned the rights of access to perform video transmission accessible for all the participants; (7) “speaker” status assigned the rights of access to operative management of scheduling conduct of a limited scope of discussions; (8) “debater” status assigned the rights of access to performance of video transmission of a limited scope of debate; (9) “debater assistant” status assigned the rights of access to limited management of debate scheduling; and/or (10) “arbiter” status assigned the rights of access to the instrument of estimating a limited scope of debate.

According to some embodiments, the suite of functional types of movable bilateral roll-up stickers with a modal window movable bilateral roll-up stickers—utilized as part of the method for generating and operating an online interactivity environment and for the organization and conduct of online discussions—may include at least: (1) personalized stickers, (2) stickers of changeable color and layout, (3) anonymous stickers and/or (4) closed stickers with an access for discussants to be opened only by the sticker author.

According to some embodiments, as part of the method for generating and operating an online interactivity environment and for the organization and conduct of online discussions, facilitator selected and relayed discussion format type may trigger one or all of the following corresponding system actions, wherein:

Upon facilitator selection of a “free discussion” format, assigning all the participants access rights for creating discussion threads arranged by the participants at their discretion and represented in the form of fields with text boxes, visual objects, and spatial areas chosen by the participants irrespective of other discussion threads;

Upon facilitator selection of a “focused discussion” format, structuring the discussion as a regular complex of discussion threads represented in the form of fields with text boxes, visual objects, and space areas interconnected with the fields of the previous and subsequent discussion threads, the discussion threads in the complex being arranged in a succession determined by the algorithm selected from a suite comprising at least the following algorithm types: reflection of experience, clarification of positions, approximation of positions, polemics, making decisions, examining, planning future, and/or case solution.

Upon facilitator selection of a “multistage facilitated discussion” format, successively applying a suite of discussion algorithms at different stages of the discussion: (1) providing a ranked multistage structure of a discussion in the form of a suite of thread complexes, the suite consisting of a sequence of stages, wherein the suite of thread complexes, on its first stage, contains N copies of thread complexes corresponding to the number of groups of the first-stage discussion participants; and wherein the suite of thread complexes, in the process of proceeding to the following discussion stages, contains a decreasing number of thread complex copies wherein the number of groups and copies of threads at a given stage i equals to:

Ni=(Xi−1)*(Ni−1/Yi−1)/Yi

Where Y is the number of participants in a group, and X is the quantity of the group representatives to participate in the discussion on the next stage; (2) providing at each discussion stage in each copy of thread complexes, the last thread which is completed by selecting X representatives from each group of Y participants to take part in the next-step discussion within mixed groups of representatives; and/or (3) changing the status of the participants who were not selected at any discussion stage as their group representatives, to an “observer” status retaining only the access right to comment to posts and/or content presented by other participants.

Selection of participants taking part in the next stage of the discussion depends on their acquired scores that are based on participant discussion portraits. At each stage, all the parameters N, X, Y in the equation above may be chosen in such a way that at the following stages they stay integers. Eventually at the final stage of the discussion N(final)=1, and each stage X is less or equal to Y. The selection of participants to take part in the next-step discussion depends on their acquired scoring that is based on the participant discussion portrait.

Upon facilitator selection of a “collanar” composite discussion format which is a composition of at least one common video transmission for all the participants and an unlimited number of focused discussions in groups of participants: (1) choosing instruments for acquisition and creation of content for dispute from a selection of at least textual, graphic, audio and video materials, audio and video transmissions, text and graphics editors, means of problem formulation, computation, analysis, and planning; (2) providing an ordered discussion structure in the form of a suite of discussion thread complexes in a quantity corresponding to the number of discussion participant groups and at least one discussion thread common for all complexes, which includes at least one video transmission common for all; and/or (3) assigning to at least one participant the “master” status and the rights of access to the video transmission management.

Upon facilitator selection of a “debate” composite discussion format: (1) providing within the ordered structure of the suite of discussion thread complexes, a thread common for all complexes, which comprises at least two video transmissions common for all participants; (2) assigning a “debater” status to at least two participants; and: a “speaker”, “arbiter”, “debater assistant” and “master” statuses to at least one participant to work in a discussion thread common for all complexes, which comprises at least two video conferences common for all participants; (3) distributing between the rest of the participants the access rights corresponding to the statuses of “observer” and “audience”; and/or (4) allocating access rights to participants with different statuses in accordance with the effective rules.

Upon facilitator selection of a “PRACTICUM collanar” composite discussion format: (1) providing within the ordered structure of the suite of discussion thread complexes at least one thread common for all complexes, which comprises at least one interactive instrument of content acquisition and formation; and/or (2) assigning the “video conference presenter” and “tutor” statuses and corresponding access rights each to at least one participant.

Upon facilitator selection of a “COMBINATION collanar” composite discussion format: (1) providing an ordered structure of a suite of discussion thread complexes each complex containing at least one thread which comprises at least one video transmission accessible to all participants; and one video transmission and one interactive instrument of content acquisition and formation, which are accessible only to the participants of a limited scope of groups; and/or (2) assigning the “group leader”, “expert”, “consultant”, “tutor” “video conference presenter” statuses and corresponding access rights each to at least one participant.

According to some embodiments of the present invention, a computerized system implemented method for facilitating virtual discussion may include: a predetermined list of participants and predetermined assignment of their roles that is essentially based on the hierarchy of participants wherein the hierarchy presumes the existence of at least two different levels. The usage of several terminals where the number of terminals is equal or exceeds a number of registered participants. The usage of special computer logic (e.g. program and/or circuits) that provides a discussion desk that visually contains the entire information on both the current state of the discussion and all of its earlier stages.

According to some embodiments: the discussion desk may be presented on one or several computer screens of the terminals; each participant may interact with others or anyone of them through his terminal solely; the discussion desk may essentially include several fields of different designs and designations; the computer logic may provide a list of tools for making certain verbal statements; the tools may include virtual stickers that contain the statement of a participant; the tools may include Doings—as described herein; the stickers may be commented to either by any participant or by some of them; the stickers may have different form, different color, different design and/or different destination; the stickers may be of different types such as public sticker, anonymous sticker, open sticker, confidential sticker, closed sticker, sticker-quest; the tools (e.g. the stickers) may have certain hierarchy; the hierarchy of participants and the hierarchy of tools may correspond to each other in such a way that a participant of higher hierarchical level has access to all the scope of the tools of the lower level and to some tools of the higher level and/or such that the access to the certain tools is defined by the role of certain participant.

According to some embodiments: the computer logic may provide a list of tools for non-verbal communication; the tools may include usage of Doings of various shapes and colors; the tools may include usage of stickers of different shapes and colors; the tools may include a possibility to place the Stickers and the Doings in the certain fields of the discussion desk; the fields of the discussion desk may express: the attitude (are emotionally marked) “good-evil”, “like-hate”, “important unimportant”, “urgent-may wait”, etc.; the tools may include usage of special Stickers like: personalized stickers, anonymous stickers, etc.; the field of the discussion desk may contain actual scores of participants or suggested actions.

According to some embodiments, a computer-based system running software tool that realizes the above described methods may comprise: input devices (e.g. terminals) for receiving data from participants, output devices for presenting the data to participants and a central computer unit(s).

According to some embodiments, discussion tools may include audio and/or video records of the statements of participants that may be placed at the certain field of the discussion desk and commented to by discussion participants having access to these fields; some participants may commence/arrange a chat area and place this chat in the appropriate field of the discussion desk.

According to some embodiments, one or more of the hierarchies of the discussion may be changed (e.g. by the facilitator) in the course of discussion depending on its actual state and instant tasks, thus the hierarchy becomes dynamic; the dynamic hierarchy may include the change of the rights of access of several participants to several tools and/or fields; a given discussion may be naturally extended by conducting in parallel several discussions in several virtual groups when each separate group has its own copy of the discussion desk while originally all these desks are identical and afterwards each copy of the discussion desk acquires its own individuality reflecting the character of the discussion in its particular group; the hierarchy of participants and the hierarchy of tools may correspond to each other in such a way that the access to the certain tools is defined by the role of the certain participant.

According to some embodiments, at least some of the hierarchies of participants may be dynamically allocated and may be changed by the platform based on the current score of one or more participants. According to some embodiments, the process of scoring of participants may be based on their respective discussion portraits.

According to some embodiments, the discussion portrait of a given participant may include ingredients selected from the group consisting of: timing of entrance to the session and exit from the session; entrance to the discussion list and exit from the discussion list; creation and removing of stickers by this participant; moving his stickers between various positions in the discussion lists; creation and removing of tokens of certain kinds by this participant and positioning them in certain stickers; commenting in stickers; usage of timers and widgets; passing the build-inn tests; and/or scoring of the tests.

According to some embodiments, an amount of participants that was initially substantially large may be reduced consequently when the discussion moves forward to its more advanced stages while the criteria of selection of participants taking part in the next stages may be based on the comparative analysis of individual participant's scores that are granted by the platform on the basis of analysis of their acquired discussion portraits.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method for facilitating a virtual discussion, said method comprising:
compiling or receiving a list of discussion participants and their roles;
assigning a role based hierarchy to the listed participants, wherein the hierarchy presumes the existence of at least two different levels;
deploying one or more communication channels/modes between a set of computerized terminals/devices, wherein each listed participant is associated with at least one of the terminals/devices; and
rendering onto the screens of at least some of the computerized terminals/devices an interactivity environment discussion desk containing information on both the current state of the discussion and earlier stages thereof.

2. The method of claim 1, wherein the one or more communication channels/modes between the set of computerized terminals/devices allows for a given listed discussion participant to asynchronously interact with all, or a subset, of the other listed discussion participants through his terminal/device—when the terminal/device of the given listed discussion participant is positioned at a first geo-position and one or more of the terminal(s)/device(s) of the other listed discussion participants are positioned at, at least a second, other, geo-position(s) of a different time zone(s)—wherein asynchronously interacting includes:
receiving an indication of the geo-position or time zone of one or more of the terminal(s)/device(s) of the other listed discussion participants;
temporarily halting the rendering onto computerized terminals/devices of other listed discussion participants which are, based on their received geo-position or time zone, at an ‘out of activity’ time of day;
accumulating discussion related information associated with listed discussion participants to whose terminal(s)/device(s) rendering was temporarily halted; and
upon a computerized terminal/device of a listed discussion participant to whose terminal/device rendering was temporarily halted, leaving the ‘out of activity’ time of day, rendering onto his computerized terminal/device at least part of the accumulated discussion related information, associated with him.

3. The method of claim 1, wherein the discussion desk includes several fields of different designs and designations

4. The method of claim 3, wherein the discussion desk enables participant interfacing of one or more tools for making discussion related verbal or non-verbal statements.

5. The method of claim 4, wherein the tools include ‘stickers’ that contain a statement of a participant or ‘doings’ that contain a predetermined statement or response.

6. The method of claim 5, wherein the ‘stickers’ can be commented to either by any listed participant or by a subset thereof.

7. The method of claim 5, wherein the ‘stickers’ have different form, different color, different design, or different destination.

8. The method of claim 5, wherein the types of the ‘stickers’ vary and include at least: personalized stickers, public stickers, anonymous stickers, open stickers, confidential stickers, closed stickers or a sticker-quest.

9. The method of claim 4, wherein at least some of the tools have certain hierarchy between them.

10. The method of claim 9, wherein the hierarchy of participants and the hierarchy of tools correspond to each other in such a way that the access and usage of certain tools is defined by the role of accessing participant, wherein a participant of a higher role based hierarchy level is granted access to a certain set of the tools and a participant of a relatively lower role based hierarchy level is granted access to only a subset of tools from the certain set of the tools.

11. The method of claim 4, wherein the tools include ‘stickers’ that contain a statement of a participant or ‘doings’ that contain a predetermined statement or response of a participant and wherein the ‘stickers’ or the ‘doings’ are of various shapes and colors.

12. The method of claim 11, wherein the tools allow for the placing of the ‘stickers’ or the ‘doings’ in specific, participant selected, fields of the discussion desk.

13. The method of claim 12, wherein the fields of the discussion desk, onto which the ‘stickers’ or the ‘doings’ are placed, express an attitude of the placing participant by being emotionally marked.

14. The method of claim 13, wherein emotional markings are selected from a group including at least: “good-evil”, “like-hate”, “important-unimportant”, “urgent-may wait”.

15. The method of claim 14, wherein the types of the ‘stickers’ vary and include at least: personalized stickers, public stickers, anonymous stickers, open stickers, confidential stickers, closed stickers or a sticker-quest.

16. The method of claim 13, wherein fields of the discussion desk contain an actual scoring based on accumulated participant ratings or participant suggested actions.

17. The method of claim 16, wherein the scoring is a listing, or a statistical index, of one or more participant ratings.

18. The method of claim 13, wherein the tools include audio or video recording tools for recording statement of participants and wherein the recordings can be placed at a certain field of the discussion desk and commented to by participants having access to the certain field.

19. The method of claim 13, wherein the tools include chat-area tools that can be placed by a participant at a certain field of the discussion desk, wherein placed chat-areas may be engaged by participants having access to the certain field.

20. The method of claim 4, wherein the hierarchy of participants may be changed as a result of a received discussion facilitator request, making the participant hierarchy a dynamic one.

21. The method of claim 20, wherein the hierarchy of participants may be automatically changed depending on the actual state and instant tasks of the discussion, making the participant hierarchy a dynamic one.

22. The method of claim 21, wherein the dynamic hierarchy includes the change of the rights of access of several participants to several tools and fields.

23. The method of claim 22, wherein the discussion is extended by conducting, in parallel, several discussions in several virtual participant groups, wherein the original discussion desk of the discussion—rendered on the screens of the monitors/devices of the participants—is initially similar; and wherein each of the separate discussion participant groups is allocated with its own, similar, copy of the discussion desk and wherein through the course of discussion within each of the separate discussion participant groups, the discussion desk copy of each of the groups acquires its own individuality reflecting the character of the discussion in its own particular group.

24. The method according to claim 23, further comprising, calculating the number of virtual participant groups at a given stage (i), of a discussion that started from an initially similar discussion desk, wherein the number of virtual participant groups in stage (i) is equal to: the number of group representatives from the last prior discussion stage (i−1) to participate in the discussion on the next stage (i.e. on the current stage (i)), multiplied by, the ratio between the number of groups in the last prior discussion stage (i−1) and the number of participants [in a group] in the last prior discussion stage (i−1); divided by the number of participants [in a group] in the current discussion stage (i).

25. A system for facilitating a virtual discussion, said system comprising:
a virtual environment deployment engine for compiling or receiving a list of discussion participants and their roles and for assigning a role based hierarchy to the listed participants, wherein the hierarchy presumes the existence of at least two different levels;
a communication control module for deploying and controlling communication access to one or more communication channels/modes between a set of computerized terminals/devices, wherein each listed participant is associated with at least one of the terminals/devices; and
said virtual environment deployment engine for rendering onto the screens of at least some of the computerized terminals/devices an interactivity environment discussion desk containing information on both the current state of the discussion and earlier stages thereof.

26. The system of claim 25, wherein the one or more communication channels/modes between a set of computerized terminals/devices allows for a given listed participant to interact with other listed participants or anyone of them through his terminal/device solely.

27. The system of claim 26, wherein the discussion desk includes several fields of different designs and designations and an interface to a one or more tools for making discussion related verbal or non-verbal statements.

28. The system of claim 27, wherein at least some of the tools have certain hierarchy between them, wherein the hierarchy of participants and the hierarchy of tools correspond to each other in such a way that the access and usage of certain tools is defined by the role of accessing participant, wherein said communication control module grants access to a participant of a higher role based hierarchy level to a certain set of the tools and grants access to a participant of a relatively lower role based hierarchy level to only a subset of tools from the certain set of the tools.

29. The system of claim 28, wherein at least some of the hierarchies of participants are dynamically allocated and may be changed by the platform based on the current score of participant.

30. The system of claim 29, wherein the process of scoring of participant is based on his discussion portrait.

31. The system of the claim 30, wherein the discussion portrait of a given participant includes ingredients selected from the group consisting of: timing of entrance to the session and exit from the session; entrance to the discussion list and exit from the discussion list; creation and removing of stickers by this participant; moving his stickers between various positions in the discussion lists; creation and removing of tokens of certain kinds by this participant and positioning them in certain stickers; commenting in stickers; usage of timers and widgets; passing the build-inn tests; and scoring of the tests.

32. The system of the claim 31, wherein an amount of participants that was initially substantially large is reduced consequently when the discussion moves forward to its more advanced stages while the criteria of selection of participants taking part in the next stages is based on the comparative analysis of individual participant's scores that are granted by the platform on the basis of analysis of their acquired discussion portraits.
